(19) United States
(12) Patent Application Publication
(10) Pub. No.: US 2022/0035010 A1
(43) Pub. Date: Feb. 3, 2022

(54) METHODS AND SYSTEMS FOR POWER-EFFICIENT SUBSAMPLED 3D IMAGING

(71) Applicants: Sense Photonics, Inc., Durham, NC (US); The University Court of The University of Edinburgh, Edinburgh (GB)

(72) Inventors: Salvatore Caporale, Edinburgh (GB); David Storrar, Falkirk (GB); Hod Finkelstein, Berkeley, CA (US); Tarek Al Abbas, Edinburgh (GB); Robert Henderson, Edinburgh (GB)

(21) Appl. No.: 17/391,864

(22) Filed: Aug. 2, 2021

Related U.S. Application Data
(60) Provisional application No. 63/060,408, filed on Aug. 3, 2020.
(60) Provisional application No. 63/137,431, filed on Jan. 14, 2021.

(51) Int. Cl. G01S 7/4865; G01S 7/484; G01S 7/4863

(52) U.S. Cl. CPC G01S 7/4865; G01S 7/4863; G01S 7/484

(57) ABSTRACT

A Time of Flight (ToF) system includes an emitter array comprising one or more emitters configured to emit optical signals, a detector array comprising a plurality of detectors that are configured to output respective detection signals responsive to the optical signals that are reflected from a target, and a control circuit. The control circuit is configured to: control the emitter array to emit a first optical signal; and provide a plurality of activation signals to a subset of the plurality of detectors responsive to the first optical signal to activate respective ones of the detectors of the subset for a first duration to generate detection signals associated with the first optical signal. Respective ones of the plurality of activation signals are offset from one another by respective time offsets.

### CLAIM OF PRIORITY

This application claims the benefit of priority from U.S. Provisional Patent Application No. 63/060,408, entitled “METHODS AND SYSTEMS FOR CLOSE RANGE/RETROREFLECTOR COUNTERMEASURES,” filed Aug. 3, 2021, in the United States Patent and Trademark Office and U.S. Provisional Patent Application No. 63/137,431, entitled “METHODS AND SYSTEMS FOR POWER-EFFICIENT SUBSAMPLED 3D IMAGING,” filed Jan. 14, 2021, in the United States Patent and Trademark Office, the disclosures of which are incorporated by reference herein in their entirety.

### FIELD

The present invention is directed to Light Detection and Ranging (LIDAR or lidar) systems, and more particularly, to methods and devices to increase an accuracy in target detection for time-of-flight LIDAR systems.

### BACKGROUND

Time of flight (ToF) based imaging is used in a number of applications including range finding, depth profiling, and 3D imaging (e.g., lidar). Direct time of flight measurement includes directly measuring the length of time between emitting radiation and sensing the radiation after reflection from an object or other target. From this, the distance to the target can be determined. Indirect time of flight measurement includes determining the distance to the target by phase modulating the amplitude of the signals emitted by emitter element(s) of the lidar system and measuring phases (e.g., with respect to delay or shift) of the echo signals received at detector element(s) of the lidar system. These phases may be measured with a series of separate measurements or samples.

The emitter elements may be controlled to emit radiation over a field of view for detection by the detector elements. Emitter elements for ToF measurement may include pulsed light sources, such as LEDs or lasers. Examples of lasers that may be used include vertical cavity surface emitting lasers (VCSELs). Methods for configuring lasers for use in optical systems are discussed in U.S. Pat. No. 10,244,181 to Warren entitled “COMPACT MULTI-ZONE INFRARED LASER ILLUMINATOR.”

In specific applications, the sensing of the reflected radiation from the emitter element in either direct or indirect time of flight systems may be performed using an array of single-photon detectors, such as a Single Photon Avalanche Diode (SPAD) array. SPAD arrays may be used as solid-state detectors in imaging applications where high sensitivity and timing resolution are useful.

A SPAD is based on a p-n junction device biased beyond its breakdown region, for example, by or in response to a strobe signal having a desired pulse width (also referred to herein as “strobing”). The high reverse bias voltage generates a sufficient magnitude of electric field such that a single charge carrier introduced into the depletion layer of the device can cause a self-sustaining avalanche via impact ionization. Once the avalanche occurs, the SPAD may be unable to detect additional photons (e.g., the SPAD may experience a “dead” time). The avalanche is quenched by a quench circuit, either actively or passively, to allow the device to be “reset” to detect further photons. The initiating charge carrier can be photo-electrically generated by means of a single incident photon striking the high field region. It is this feature which gives rise to the name “Single Photon Avalanche Diode.” This single photon detection mode of operation is often referred to as “Geiger Mode.”

In some conventional configurations, a SPAD in an array may be strobed by pre-charging the SPAD beyond its breakdown voltage at a time correlated with the firing of an emitter pulse. If a photon is absorbed in the SPAD, it may trigger an avalanche breakdown. This event can trigger a time measurement in a time-to-digital converter, which in turn can output a digital value corresponding to the arrival time of the detected photon. A single arrival time carries little information because avalanches may be triggered by ambient light, by thermal emissions within the diode, by a trapped charge being released (afterpulse), and/or via tunneling. Moreover, SPAD devices may have an inherent jitter in their response. Statistical digital processing is typically performed in 3D SPAD-based direct TOF imagers.

Data throughput in such 3D SPAD-based direct TOF imagers is typically high. A typical acquisition may involve tens to tens of thousands of photon detections, depending on the background noise, signal levels, detector jitter, and/or required timing precision. The number of bits required to digitize the time-of-arrival (TOA) may be determined by the ratio of range to range resolution. For example, a LIDAR with a range of 200 m and range resolution of 5 cm may require 12 bits. If 500 acquisitions are required to determine a 3D point in a point cloud, 500 time-to-digital conversions may be performed, and 6 kbits may be stored for processing. For an example LIDAR system with 0.1×0.1 degree resolution and 120 degrees (horizontal) by 30 degrees (vertical) range, 360,000 acquisitions may be performed per imaging cycle. This can utilize 180 million TDC operations and 2.16 Gbits of data. Typical refresh rates for some applications (e.g., autonomous vehicles) may be 30 frames per second. Therefore, a SPAD-based LIDAR achieving typical target performance specifications may require 5.4 billion TDC operations per second, moving and storing 64.8 Gbit of information and processing 360,000×30=10.8 million acquisitions per second.

In addition to such astronomical processing requirements, an architecture that uses direct digitization of photons arrival times may have area and power requirements that may likewise be incompatible with mobile applications, such as for autonomous vehicles. For example, if a TDC is integrated into each pixel, a large die may only fit 160×128 pixels, due for instance to the low fill factor of the pixel (where most of the area is occupied by control circuitry and the TDC). The TDC and accompanying circuitry may offer a limited number of bits.

Another deficiency of some existing SPAD arrays is that once a SPAD is discharged, it remains discharged, or “blind”, for the remainder of the cycle. Direct sunlight is usually taken as 100 k lux. In one example, at 940 nm, the direct beam solar irradiance is 0.33 W/m²/nm. At 940 nm, photon energy is 2.1×10⁻¹⁹ J, so 0.33/2.1×10⁻¹⁹=1.6×10¹⁸ photons impinge per m² per second in a 1 nm band. Typical LIDAR filters may have a pass band of approximately 20 nm. For a 10 μm diameter SPAD, this translates to 3.2×10⁹ photons per second. Light takes 400/3×10⁸=1.3 μs to traverse 2×200 m. During this time, 3.2×10⁹×1.3×10⁻⁶=4,160 photons on average will impinge on the SPAD. As soon as the first photon induces an avalanche, that SPAD will become deactivated. Consequently, under these conditions, some SPAD 3D cameras may not be operable in direct sunlight.

One method to address high ambient light conditions implements a spatio-temporal correlator. In one example, multiple pixels may be used to digitally detect correlated events, which can be attributed to a pulsed source rather than to ambient light. Times of arrival of a plurality of SPADs per pixel may be digitized using a fine and coarse TDC, and results may be stored in a 16-bit in-pixel memory per SPAD. The results may be offloaded from the chip to be processed in software. The software may select coincident arrivals to form a histogram of arrival times per pixel per frame. The histogram may be processed to provide a single point on the point cloud. This scheme may quadruple the area and processing power versus generic imagers. By using multiple correlated arrivals, this example system may set limits on emitter power, maximal target range and/or target reflectivity, because a single pulse may provide multiple detected photons at the detector. Furthermore, the area required for the circuitry may allow for a limited number of pixels, which may include only a small portion of the overall die area. Thus, a high-resolution imager may be difficult or impossible to implement using this scheme. For example, the data throughput to process a 2×192 pixel array may be 320 Mbit/sec, so scaling these 2×192 pixels to the 360,000 pixels mentioned above for a LIDAR system may be unrealistic.

### SUMMARY

Some embodiments described herein provide a lidar system including one or more emitter units (including one or more semiconductor lasers, such as surface- or edge-emitting laser diodes; generally referred to herein as emitters, which output emitter signals), one or more light detector pixels (including one or more semiconductor photodetectors, such as photodiodes, including avalanche photodiodes and single-photon avalanche detectors; generally referred to herein as detectors, which output detection signals in response to incident light), and one or more control circuits that are configured to selectively operate subsets of the emitter units and/or detector pixels (including respective emitters and/or detectors thereof, respectively) to provide a 3D time of flight (ToF) lidar system. Some embodiments of the present disclosure provide measurement systems and related control circuits that are configured to compensate for pulse narrowing due to sensor nonlinearities by delaying or offsetting the timing of a detector strobe pulse relative to the timing of the emitter signal so that the effective return signal being measured by the use of a histogram is a linear superimposition of slightly displaced narrower pulses of the return signal.

According to some embodiments of the present disclosure, a Time of Flight (ToF) system includes: an emitter array comprising one or more emitters configured to emit optical signals; a detector array comprising a plurality of detectors that are configured to output respective detection signals responsive to the optical signals that are reflected from a target; and a control circuit. The control circuit is configured to: control the emitter array to emit a first optical signal; and provide a plurality of activation signals to a subset of the plurality of detectors responsive to the first optical signal to activate respective ones of the detectors of the subset for a first duration to generate detection signals associated with the first optical signal. Respective ones of the plurality of activation signals are offset from one another by respective time offsets.

In some embodiments, the one or more emitters comprise a laser, and the respective time offsets are based on a pulse width of the first optical signal.

In some embodiments, the first duration corresponds to a distance subrange of a distance range of the ToF system.

In some embodiments, the respective time offsets are associated with portions of the distance subrange, and, responsive to the first optical signal, respective durations of activation of the respective ones of the detectors are offset from one another by the respective time offsets and overlap in time.

In some embodiments, the control circuit is further configured to divide the first duration into a plurality of bins, each bin having a bin width that is a subset of the first duration, and the detection signals are associated with one of the plurality of bins.

In some embodiments, the respective time offsets are based on the bin width.

In some embodiments, the control circuit is further configured to: sum photon counts associated with time-aligned ones of the plurality of bins to generate a summed histogram; and calculate a leading edge of a return signal associated with the first optical signal.

In some embodiments, the control circuit is further configured to: detect a peak and a rising edge of the summed histogram; and calculate the leading edge of the return signal based on the peak and the rising edge of the summed histogram.

In some embodiments, the control circuit is further configured to calculate the leading edge of the return signal based on a look-up table.

In some embodiments, the subset of the plurality of detectors is a first subset, the detection signals are first detection signals, and the plurality of activation signals is first plurality. The control circuit is further configured to: control the emitter array to generate a second optical signal; and provide a second plurality of activation signals to a second subset of the plurality of detectors to activate the second subset for the first duration to generate second detection signals associated with the second optical signal. Respective ones of the plurality of second activation signals are offset from one another by the respective time offsets.

In some embodiments, a first number of detectors in the first subset is different than a second number of detectors in the second subset.

In some embodiments, the first subset comprises at least one first detector that is not included in the second subset and at least one second detector that is included in the second subset.

In some embodiments, the first subset and the second subset are a same subset, and the control circuit is further configured to: divide the first duration into a plurality of bins, each bin having a bin width that is a subset of the first duration; calculate a first leading edge of a first return signal associated with the first optical signal by summing photon counts associated with time-aligned ones of the plurality of bins associated with the first subset to generate a summed histogram; and calculate a second leading edge of a second return signal associated with the second optical signal by individually analyzing respective ones of the plurality of bins associated with the second subset.

In some embodiments, the first optical signal is associated with a first distance range of the ToF system that is closer than a second distance range that is associated with the second optical signal.

In some embodiments, the control circuit is further configured to calculate the second leading edge of the second return signal by compensating for the respective time offsets.

In some embodiments, calculating the first leading edge of the first return signal associated with the first optical signal by summing photon counts associated with the time-aligned ones of the plurality of bins is performed responsive to determining that an estimated range of the target is less than a predetermined threshold value.

In some embodiments, the predetermined threshold value is one-third of a maximum detection range of the ToF system.

According to some embodiments of the present disclosure, a Time of Flight (ToF) system includes: an emitter array comprising one or more emitters configured to emit optical signals; a detector array comprising one or more detectors that are configured to output respective detection signals responsive to the optical signals that are reflected from a target; and a control circuit. The control circuit is configured to: control the emitter array and/or the detector array to generate first detection signals associated with a first subset of the optical signals that are received by the detector array during a first duration that corresponds to a distance subrange of a distance range of the ToF system; control the emitter array and/or the detector array to generate second detection signals associated with a second subset of the optical signals that are received by the detector array during the first duration that corresponds to the distance subrange by varying, by respective time offsets, an elapsed time between an emission of the second subset of the optical signals by the one or more emitters and activation of the one or more detectors to detect the second subset of the optical signals; and determine whether the target based is within the distance subrange based on the first and second detection signals.

In some embodiments, the one or more emitters comprise a laser, and the respective time offsets are based on a pulse width of the second subset of the optical signals.

In some embodiments, the respective time offsets are associated with a portion of the distance subrange.

In some embodiments, the control circuit is further configured to divide the first duration into a plurality of bins, each bin having a bin width that is a subset of the first duration, and the first and second detection signals are associated with one of the plurality of bins.

In some embodiments, the respective time offsets are based on the bin width.

In some embodiments, the control circuit is further configured to activate the detector array for a plurality of subframes during a frame that corresponds to the distance range of the ToF system, and a first subframe of the plurality of subframes corresponds to the distance subrange of the distance range of the ToF system.

In some embodiments, the control circuit is further configured to vary, by the respective time offsets, the elapsed time between the emission of the second subset of the optical signals by the one or more emitters and the activation of the one or more detectors responsive to determining that a photon pile-up condition has occurred.

In some embodiments, the control circuit is further configured to determine that the photon pile-up condition has occurred by comparing a count of detected photons represented by the first and/or second detection signals to a predetermined threshold.

In some embodiments, the control circuit is further configured to adjust an estimated distance to the target by a correction factor based on the first and/or second detection signals.

In some embodiments, the control circuit is further configured to determine the correction factor based on a look-up table.

In some embodiments, the control circuit is further configured to vary, by the respective time offsets, the elapsed time between the emission of the second subset of the optical signals by the one or more emitters and the activation of the one or more detectors based on varying respective timings of strobe signals transmitted to the detector array that controls activation times of the one or more detectors to detect the second subset of the optical signals.

In some embodiments, the control circuit is further configured to vary, by the time offset, the elapsed time between the emission of the second subset of the optical signals by the one or more emitters and the activation of the one or more detectors based on varying respective activation times of the one or more emitters to emit the second subset of the optical signals.

In some embodiments, the control circuit is further configured to detect a count of photons detected by the detector array based on the first and second detection signals.

In some embodiments, respective time offsets are based on a predetermined effective range resolution of the ToF system.

In some embodiments, the respective time offsets are non-uniform.

In some embodiments, the emitter array comprises a plurality of groups of the one or more emitters, and the control circuit is further configured to vary respective timings of activation signals sent to respective ones of the groups of the one or more emitters by the respective time offsets.

According to some embodiments of the present disclosure, a Time of Flight (ToF) system includes: one or more emitters that are configured to emit optical signals responsive to emitter control signals; one or more detectors that are configured to be activated responsive to detector strobe signals, and are configured to output detection signals responsive to the optical signals that are reflected from a target; and a control circuit. The control circuit is configured to: output the detector strobe signals corresponding to a respective distance subrange of the ToF system at different offsets or delays relative to respective timings of the emitter control signals; or output the emitter control signals at different offsets or delays relative to respective timings of the detector strobe signals corresponding to a respective distance subrange of the ToF system.

In some embodiments, a readout signal corresponding to the respective distance subrange comprises a distribution of the detection signals at the different offsets or delays.

In some embodiments, the control circuit is further configured to: associate a plurality of bins of a histogram with the respective distance subrange, each bin having a bin width that is a subset of a time duration that corresponds to the respective distance subrange; and calculate a first leading edge of a first return signal associated with a first optical signal of the optical signals by summing photon counts associated with time-aligned ones of the plurality of bins of the histogram to generate a summed histogram.

In some embodiments, the control circuit is further configured to calculate a second leading edge of a second return signal associated with a second optical signal of the optical signals by individually analyzing respective ones of the plurality of bins of the histogram and compensating for the different offset or delays.

In some embodiments, the first optical signal is associated with a first distance range of the ToF system that is closer than a second distance range that is associated with the second optical signal.

In some embodiments, calculating the first leading edge of the first return signal associated with the first optical signal by summing photon counts associated with the time-aligned ones of the plurality of bins is performed responsive to determining that an estimate range of the target is less than a predetermined threshold value.

In some embodiments, the predetermined threshold value is one-third of a maximum detection range of the ToF system.

In some embodiments, calculating the first leading edge of the first return signal comprising determining a peak and a rising edge of the photon counts associated with the time-aligned ones of the plurality of bins of the histogram.

According to some embodiments of the present disclosure, a Time of Flight (ToF) system includes: a control circuit configured to control emitters of an emitter array and/or detectors of a detector array to generate detection signals by varying, by one or more offsets, an elapsed time between emission of optical signals by the emitters and activation of the detectors to detect the optical signals for a respective distance subrange of the ToF system, and to output a readout signal corresponding to the respective distance subrange and comprising a distribution of the detection signals based on the one or more offsets.

According to some embodiments of the present disclosure, a method of operating a Time of Flight (ToF) system includes: controlling an emitter of an emitter array to emit a first optical signal; and providing a plurality of activation signals to a subset of a plurality of detectors responsive to the first optical signal to activate respective ones of the detectors of the subset for a first duration to generate detection signals associated with the first optical signal. Respective ones of the plurality of activation signals are offset from one another by respective time offsets.

In some embodiments, the respective time offsets are based on a pulse width of the first optical signal.

In some embodiments, the first duration corresponds to a distance subrange of a distance range of the ToF system.

In some embodiments, the respective time offsets are associated with portions of the distance subrange.

In some embodiments, responsive to the first optical signal, respective durations of activation of the respective ones of the detectors are offset from one another by the respective time offsets and overlap in time.

In some embodiments, the method further comprises dividing the first duration into a plurality of bins, each bin having a bin width that is a subset of the first duration, and the detection signals are associated with one of the plurality of bins.

### BRIEF DESCRIPTION OF THE DRAWINGS

FIG. 1A is an example lidar system according to some embodiments of the present disclosure.

FIG. 1B is an example of a control circuit that generates emitter and/or detector control signals according to some embodiments of the present disclosure.

FIG. 1C is a diagram illustrating relationships between image frames, subframes, laser cycles, and time gates as utilized in some lidar systems.

FIGS. 2A and 2B are simplified graphs showing examples of photon counts for a non-reflective and a reflective target, respectively. FIG. 2C is a graph illustrating the phenomenon of pulse narrowing due to sensor nonlinearities.

FIG. 3 is a schematic graph illustrating a laser clock vs. strobe pulse based on an example using four detection window offsets that are offset by one-quarter pulse length, according to some embodiments of the present disclosure.

FIG. 4 is a graph illustrating the signals associated with the shifting offsets of FIG. 3.

FIG. 5 is a schematic graph illustrating a laser clock vs. strobe pulse based on an example using eight offsets based on the bin duration.

FIGS. 6 and 7 are graphs illustrating the signals associated with the shifting offsets of FIG. 5.

FIG. 8 illustrates the application of a mean error correction to a detected signal, according to some embodiments of the present disclosure.

FIGS. 9A to 9E are simplified graphs showing examples of adjusting offsets within a detection window to determine a location of a target, according to some embodiments of the present disclosure.

FIG. 10 is a schematic graph illustrating a laser activation signal vs. a strobe activation signal based on an example using four laser pulse offsets that are offset by one-quarter pulse width, according to some embodiments of the present disclosure.

FIG. 11 illustrates an emitter array configured to incorporate dithering, according to some embodiments of the present disclosure.

FIG. 12 is a flowchart of a method to calculate a distance to a target object according to some embodiments of the present disclosure.

FIGS. 13A to 13C illustrate examples of various macropixel configurations according to some embodiments of the present disclosure.

FIGS. 14A to 14C are schematic graphs illustrating methods of utilizing offset detectors in determining a range to a target, according to some embodiments of the present disclosure.

FIGS. 15A and 15B are graphs illustrating methods of combining histograms from offset detectors in a macropixel, according to some embodiments of the present disclosure.

FIGS. 16A to 16C are schematic diagrams illustrating a method for determining the leading edge of the return pulse according to some embodiments of the present disclosure.

FIGS. 17 and 18 illustrate examples of a method of determining a leading edge of a return signal based on a time-aligned summation of histograms from a plurality of time-offset detectors, according to some embodiments of the present disclosure.

FIG. 19 is a schematic diagram of a conversion of an array of detectors to an array of macropixels, according to some embodiments of the present disclosure.

FIG. 20 is a schematic diagram of the formation of a plurality of macropixels from a set of detectors, according to some embodiments of the present disclosure.

FIGS. 21A and 21B illustrate example combinations of detectors into a macropixel, according to some embodiments of the present disclosure.

FIG. 22 is a schematic diagram illustrating an example of combining detectors, according to some embodiments of the present disclosure.

FIGS. 23A to 23D illustrate example circuits for generating the time offsets for the detectors of a macropixel, according to some embodiments of the present disclosure.

### DETAILED DESCRIPTION

A lidar system may include an array of emitters and an array of detectors, or a system having a single emitter and an array of detectors, or a system having an array of emitters and a single detector. As described herein, one or more emitters may define an emitter unit, and one or more detectors may define a detector pixel. A flash lidar system may acquire a three-dimensional perspective (e.g., a point cloud) of one or more targets by emitting light from an array of emitters, or a subset of the array, for short durations (pulses) over a field of view (FoV) or scene, and detecting the echo signals reflected from the targets in the FoV at one or more detectors. A non-flash or scanning lidar system may generate image frames by scanning light emission over a field of view or scene, for example, using a point scan or line scan to emit the necessary power per point and sequentially scan to reconstruct the full FoV.

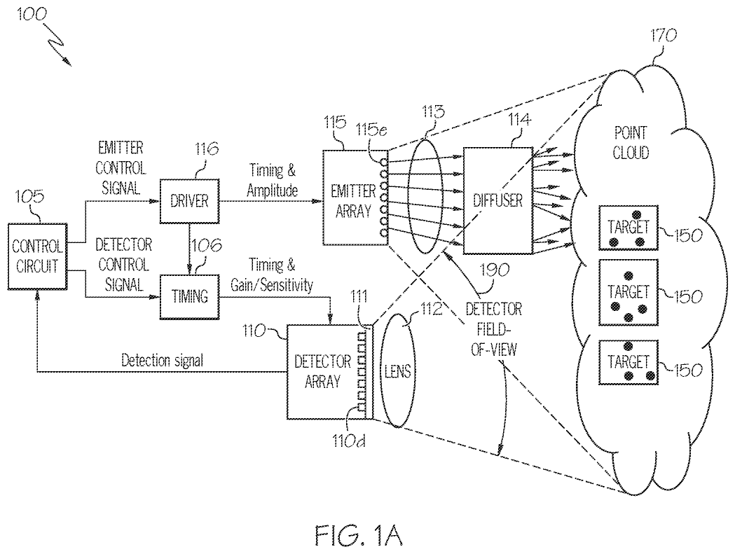

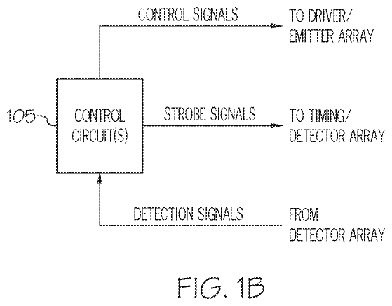

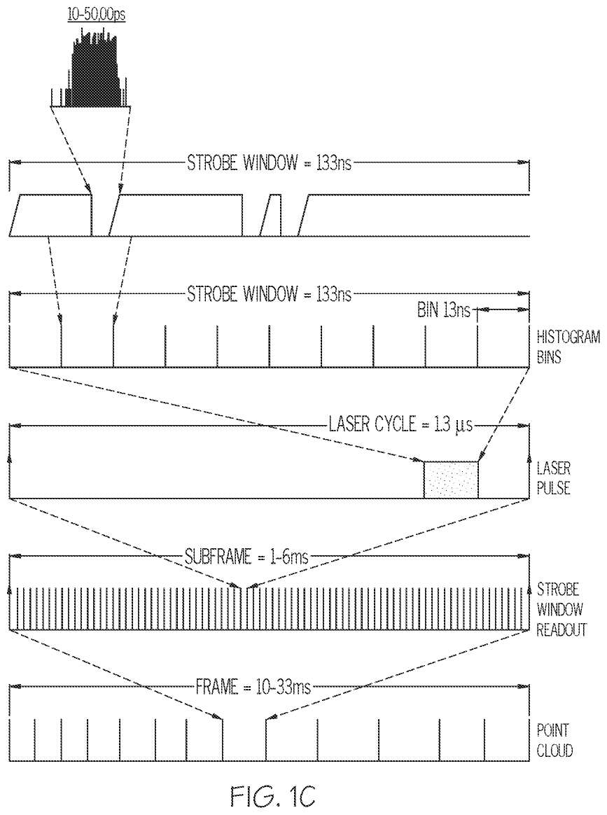

An example of a lidar system or circuit 100 in accordance with embodiments of the present disclosure is shown in FIG. 1A. The lidar system 100 includes a control circuit 105, a timing circuit 106, an emitter array 115 including a plurality of emitters 115e, and a detector array 110 including a plurality of detectors 110d. The detectors 110d include time-of-flight sensors (for example, an array of single-photon detectors, such as SPADs). One or more of the emitter elements 115e of the emitter array 115 may define emitter units that respectively emit a radiation pulse or continuous wave signal (for example, through a diffuser or optical filter 114) at a time and frequency controlled by a timing generator or driver circuit 116. In particular embodiments, the emitters 115e may be pulsed light sources, such as LEDs or lasers (such as vertical cavity surface emitting lasers (VCSELs)). Radiation is reflected back from a target 150, and is sensed by detector pixels defined by one or more detector elements 110d of the detector array 110. The control circuit 105 implements a pixel processor that measures and/or calculates the time of flight of the illumination pulse over the journey from emitter array 115 to target 150 and back to the detectors 110d of the detector array 110, using direct or indirect ToF measurement techniques.

In some embodiments, an emitter module or circuit 115 may include an array of emitter elements 115e (e.g., VCSELs), a corresponding array of optical elements 113,114 coupled to one or more of the emitter elements (e.g., lens(es) 113 (such as microlenses) and/or diffusers 114), and/or driver electronics 116. The optical elements 113, 114 may be optional, and can be configured to provide a sufficiently low beam divergence of the light output from the emitter elements 115e so as to ensure that fields of illumination of either individual or groups of emitter elements 115e do not significantly overlap, and yet provide a sufficiently large beam divergence of the light output from the emitter elements 115e to provide eye safety to observers.

The driver electronics 116 may each correspond to one or more emitter elements, and may each be operated responsive to timing control signals with reference to a master clock and/or power control signals that control the peak power and/or the repetition rate of the light output by the emitter elements 115e. In some embodiments, each of the emitter elements 115e in the emitter array 115 is connected to and controlled by a respective driver circuit 116. In other embodiments, respective groups of emitter elements 115e in the emitter array 115 (e.g., emitter elements 115e in spatial proximity to each other), may be connected to a same driver circuit 116. The driver circuit or circuitry 116 may include one or more driver transistors configured to control the modulation frequency, timing and amplitude of the optical emission signals that are output from the emitters 115e.

The emission of optical signals from multiple emitters 115e provides a single image frame for the flash lidar system 100. The maximum optical power output of the emitters 115e may be selected to generate a signal-to-noise ratio of the echo signal from the farthest, least reflective target at the brightest background illumination conditions that can be detected in accordance with embodiments described herein. An optional filter to control the emitted wavelengths of light and diffuser 114 to increase a field of illumination of the emitter array 115 are illustrated by way of example. In some embodiments, a polarizer may be included on the emitter and/or the receiver to reduce undesired reflections.

Light emission output from one or more of the emitters 115e impinges on and is reflected by one or more targets 150, and the reflected light is detected as an optical signal (also referred to herein as a return signal, echo signal, or echo) by one or more of the detectors 110d (e.g., via receiver optics 112), converted into an electrical signal representation (referred to herein as a detection signal), and processed (e.g., based on time of flight) to define a 3-D point cloud representation 170 of the field of view 190. Operations of lidar systems in accordance with embodiments of the present disclosure as described herein may be performed by one or more processors or controllers, such as the control circuit 105 of FIG. 1A.

In some embodiments, a receiver/detector module or circuit 110 includes an array of detector pixels (with each detector pixel including one or more detectors 110d, e.g., SPADs), receiver optics 112 (e.g., one or more lenses to collect light over the FoV 190), and receiver electronics (including timing circuit 106) that are configured to power, enable, and disable all or parts of the detector array 110 and to provide timing signals thereto. The detector pixels can be activated or deactivated with at least nanosecond precision, and may be individually addressable, addressable by group, and/or globally addressable. The receiver optics 112 may include a macro lens that is configured to collect light from the largest FoV that can be imaged by the lidar system, microlenses to improve the collection efficiency of the detecting pixels, and/or anti-reflective coating to reduce or prevent detection of stray light. In some embodiments, a spectral filter 111 may be provided to pass or allow passage of ‘signal’ light (i.e., light of wavelengths corresponding to those of the optical signals output from the emitters) but substantially reject or prevent passage of non-signal light (i.e., light of wavelengths different than the optical signals output from the emitters).

The detectors 110d of the detector array 110 are connected to the timing circuit 106. The timing circuit 106 may be phase-locked to the driver circuitry 116 of the emitter array 115. The sensitivity of each of the detectors 110d or of groups of detectors may be controlled. For example, when the detector elements include reverse-biased photodiodes, avalanche photodiodes (APD), PIN diodes, and/or Geiger-mode Avalanche Diodes (SPADs), the reverse bias may be adjusted, whereby, the higher the overbias, the higher the sensitivity.

In some embodiments, a control circuit 105, such as a microcontroller or microprocessor, provides different emitter control signals to the driver circuitry 116 of different emitters 115e and/or provides different signals (e.g., strobe signals) to the timing circuitry 106 of different detectors 110d to enable/disable the different detectors 110d so as to detect the echo signal from the target 150.

An example of a control circuit 105 that generates emitter and/or detector control signals is shown in FIG. 1B. The control circuit of FIG. 1B may represent one or more control circuits, for example, an emitter control circuit that is configured to provide the emitter control signals to the emitter array 115 and/or a detector control circuit that is configured to provide the strobe signals to the detector array 110 as described herein. Also, the control circuit 105 may include a sequencer circuit that is configured to coordinate operation of the emitters 115e and detectors 110d. More generally, the control circuit 105 may include one or more circuits that are configured to generate the respective detector signals that control the timing and/or durations of activation of the detectors 110d, and/or to generate respective emitter control signals that control the output of optical signals from the emitters 115e.

In some lidar implementations, different imaging distance ranges may be achieved by using different emitters 115e. For example, an emitter 115e configured to illuminate targets 150 up to a 200 meter (m) distance range may be operated to emit four times the power per solid angle as an emitter 115e configured to image up to a 100 m distance range. In some embodiments, a same emitter 115e may be configured to utilize different power levels depending on a distance being imaged. For example, if the lidar system 100 is configured to illuminate targets 150 at, for example, a distance of 200 meters from the emitter array 115, the emitter 115e may be driven at a first power level. If the lidar system 100 switches or is otherwise configured (e.g., dynamically) to illuminate targets 150 at, for example, a distance of 100 meters from the emitter array 115, the emitter 115e may be driven at a second power level that is less than the first power level.

Strobing as used herein may refer to the generation of detector control signals (also referred to herein as strobe signals or ‘strobes’) to control the timing and/or duration of activation (also referred to herein as strobe windows) of one or more detectors 110d of the lidar system 100. That is, some embodiments described herein can utilize range strobing (i.e., biasing the SPADs to be activated and deactivated for durations or windows of time over the emitter cycle, at variable delays with respect to the firing of the emitter (e.g., a laser), thus capturing reflected signal photons corresponding to specific distance subranges at each window/frame) to limit the amount of memory required to store time-of-arrival information. An emitter cycle (e.g., a laser cycle) refers to the time between emitter pulses. In some embodiments, the emitter cycle time is set as or otherwise based on the time required for an emitted pulse of light to travel round trip to the farthest allowed target and back, that is, based on a desired distance range. To cover targets within a desired distance range of about 200 meters, a laser in some embodiments may operate at a frequency of at most 750 kHz (i.e., emitting a laser pulse about every 1.3 microseconds or more).

A range-strobing flash lidar (e.g., with strobe windows corresponding to respective distance ranges) may use strobing for several reasons. For example, in some embodiments, detector elements may be combined into pixels and the detector elements and/or pixels may be selectively activated after the emission of optical signals to detect echo signals from a target during specific strobe windows. The detected echo signals may be used to generate a histogram of detected “counts” of photons incident on the detector from the echo signal. Examples of methods to detect a target distance based on histograms are discussed, for example, in U.S. patent application Ser. No. 16/273,783, filed Feb. 12, 2019, entitled “METHODS AND SYSTEMS FOR HIGH-RESOLUTION LONG-RANGE FLASH LIDAR,” the contents of which are incorporated herein by reference.

The detectors (e.g., SPADs) may be biased such that they are inactive during the firing of a lidar's emitter as well as during a period of time corresponding to the minimum range of the lidar system. In some implementations, an array of capacitors may be provided in the lidar system so as to allow charge distribution and fast recharging of the detector array.

In some embodiments, the detection may start with a timing signal (e.g., a start signal) shortly after the emitter (e.g., laser) fires and may end upon the earlier of a trigger by an avalanche or an end to the active time window (e.g., an end signal). In some embodiments, the detection may begin with or responsive to an avalanche, if one occurs, and may end just before the firing of the subsequent laser pulse. In some embodiments the timing signals (e.g., start and end signals) are not the start of the laser cycles or the end of the laser cycles but are signals timed between the start and the end of the cycle. In some embodiments, the timing of the start and end signals are not identical during all cycles, for example, allowing strobing of the range.

In some implementations, the recharging scheme is passive and as soon as an avalanche occurs, the SPAD device immediately and quickly recharges. In some embodiments, the recharge circuit is active, and the recharge time is electrically controlled. In some embodiments, the active recharge circuitry biases the SPADs beyond breakdown for a time correlated with the firing of a laser pulse. In some embodiments the recharge circuitry biases the SPADs for a portion of the time required for a pulse of light to traverse a round trip to the farthest target and back (e.g., a “strobe window”) and this strobe window is varied so as to strobe the range of the lidar. In some embodiments, the active recharge circuitry maintains the SPAD at its recharge state a sufficiently long time to release a sufficiently large percentage of trapped charges (for example, 1 ns, 2 ns, 3 ns, 5 ns, 7 ns, 10 ns, 50 ns, or 100 ns), and then quickly recharges the SPAD.

FIG. 1C is a diagram illustrating relationships between image frames, subframes, laser cycles, and time gates (also referred to herein as strobe windows) as utilized in some lidar systems. As shown in FIG. 1C, a strobe window having a particular duration may be activated during an example laser cycle having a particular time duration between emitted laser pulses. For example, at an operating frequency of 750 kHz, a laser cycle may be about 1.3 μs. This operating frequency is merely an example, and other potential frequencies/laser cycles may be used. For example, other operating frequencies include 375 kHz (about 2.6 μs) or 1.5 MHz (about 0.6 μs), to name just a few. Different time durations within individual laser cycles may be associated with respective strobe windows. For example, the time duration of the laser cycle may be divided into a plurality of potential strobe window durations, such as, for example, 10 strobe windows of approximately 133 ns each. A first one of these strobe windows may be active during a first one of the laser cycles, while a second one of the strobe windows may be active during a second one of the laser cycles. The strobe windows can be mutually exclusive or overlapping in time over the respective laser cycles, and can be ordered monotonically or not monotonically. Data regarding detected photons by the detector during one of the strobe windows may be stored within histogram bins. The histogram bins may be statistically analyzed to detect a peak number of detected photons within the strobe window. An image subframe may include multiple laser pulses with an associated laser cycle, with a strobe window active in each of the laser cycles. For example, there may be about 1000 laser cycles in each subframe. Each subframe may also represent data collected for a respective strobe window. A strobe window readout operation may be performed at the end of each subframe, with multiple subframes (each corresponding to a respective strobe window) making up each image frame (for example, 20 subframes in each frame). The timings shown in FIG. 1C are by way of example only, and other timings may be possible in accordance with embodiments described herein.

Some ranging operations may use a super-resolution technique for ranging targets, in which: (i) photons arrival times may be quantized and photon counts may be stored in a histogram; and (ii) the histogram bins that are identified as containing signal returns may be interpolated in order to obtain an estimate of the offset of the originating emitter signal pulse.

Such a ranging technique may verify multiple assumptions or conditions, including: (condition 1) that the duration of the emitter signal pulse is equal to or greater than the time resolution of the histogram (e.g., the histogram bin ‘size’); and (condition 2) the photon sensing is linear, i.e., the number of recorded photon counts is proportional to the photon rate from the scene.

For example, when the photodetector receives less than one photon return per emitter signal pulse, the peak position in the histogram can be interpolated to achieve high range resolutions, e.g., 10 cm max error. The one photon received by the photodetector is equally likely to come from any instant in the emitter signal pulse, which may facilitate the super-resolution.

However, when the signal photon rate exceeds the dynamic range where the sensing is linear, condition (2) is violated and the result of the interpolation may be incorrect. For example, the presence of specular reflectors such as retroreflectors (e.g., metallic boxcars, glass windows, etc.), or relatively close, bright reflectors (e.g., a person wearing a white shirt) in a field of view of the photodetector may result in a photon return rate that exceeds the detection capability of the detector (e.g., above a threshold number of counts). Moreover, as the effect of the sensor nonlinearity, such as dead-time, increases, the effective pulse measured by the sensor gets narrower (also referred to herein as ‘pulse narrowing’), thus violating condition (1).

That is, under strong signal returns, a majority or all SPADs in a pixel are likely to fire at the leading edge of return pulse, resulting in almost all histogram counts landing in a single bin. This may be referred to as a “pile up” of the photons. This has at least two consequences. One consequence is that the pixel is more likely to saturate, which compromises the background information measured in that strobe window. Another consequence is that, as the SPAD dead-time may be on the order of the laser pulse width, there may be no further range information available from the histogram, and the desired accuracy (e.g., to 10 cm) may be compromised.

As a result, the sensor may lose the capability of performing super-resolution and the resolution drops down to the bin width, e.g., 8 ns or 120 cm. In a system incorporating histograms, a strobe window may be broken into n discrete time durations, or bins. Thus, a strobe window oft time duration may be broken into n bins. The bin width, or time duration of the bin as part of the strobe window, may be given by t/n.

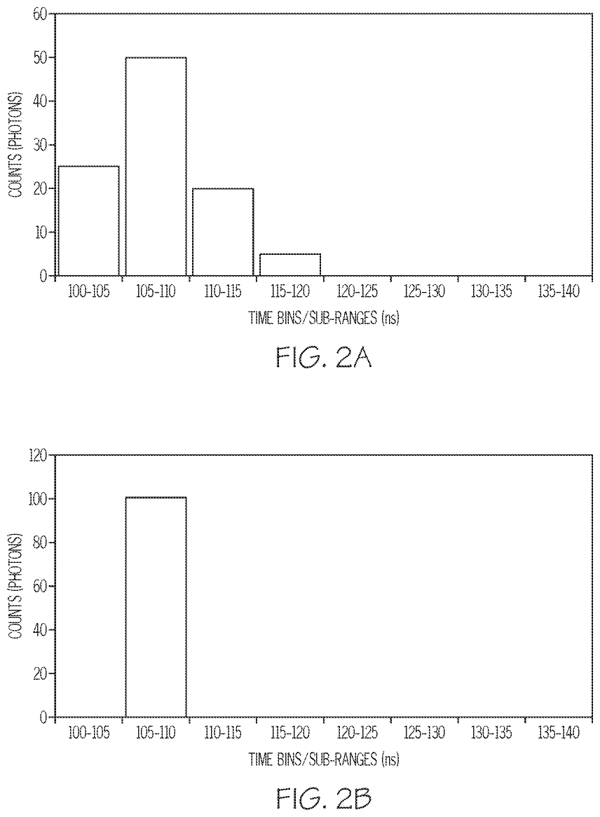

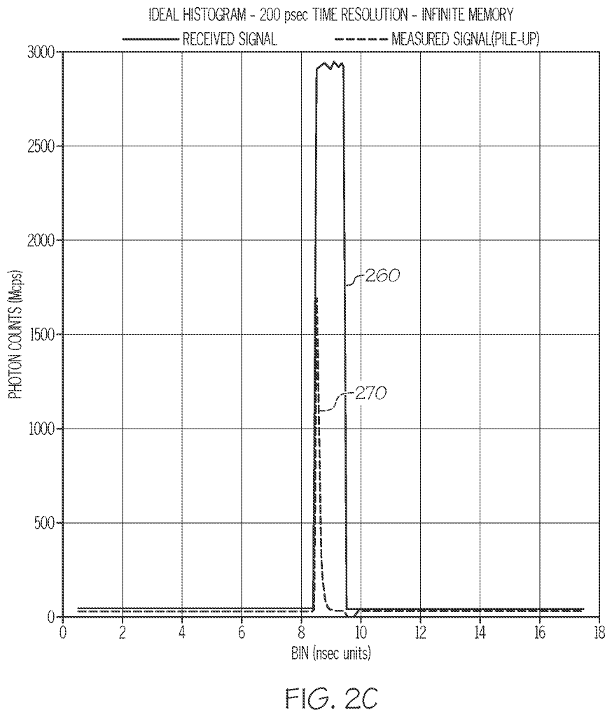

FIGS. 2A and 2B illustrate the phenomenon of photon pile-up that can affect lidar systems that utilize, for example, histogram-based distance determination. FIGS. 2A and 2B are simplified graphs showing examples of photon counts for a non-reflective and a reflective target, respectively. Referring to FIG. 2A, a set of histogram bins for a given subframe is illustrated. As described herein, a detector (e.g., a SPAD) may be activated (e.g., by a strobe signal or strobe pulse) to capture a number of photons arriving within a given duration (e.g., a subframe) after the emission of a laser pulse. The duration may correspond to the distance the light travels from the laser emitter, to the target object, and back again to be detected by the detector. As illustrated in FIG. 2A, a detector may be activated for a duration of, for example, 40 ns, by a signal such as a strobe-pulse. Thus, the strobe window may begin at 100 ns (e.g., 100 ns elapsed since the laser emitter fired), and may remain activated until an additional 40 ns has passed (e.g., to 140 ns from laser emission). By collecting photons that have traveled for 100 to 140 ns to the target object and back, the LIDAR system can determine a distance of the target object. The 40 ns duration of the strobe window is merely an example, and other durations are possible without deviating from the present disclosure.

To make the distance more granular, the subframe may be divided into a number of time slices or bins. In FIG. 2A, the bins are divided into 5 ns segments, but the present disclosure is not limited thereto. Each bin will be updated with a count of the number of photons that are detected within a timeframe associated with that particular bin. For example, a count of the number of photons that are detected within 100 to 105 ns from the emission of the laser pulse may be associated with and/or stored in a bin covering the time ranges from 100-105 ns. A number of laser pulses may be repeated (e.g., hundreds of laser pulses) and the counts may be collected for each of the bins for the particular subframe duration being analyzed (e.g., 100-140 ns). In FIGS. 2A and 2B, an example of 100 laser pulses for a subframe is shown, but this is merely an example, and other values could be used. In the example of FIGS. 2A and 2B, it is assumed that a target object is at a distance that would correspond to a 106.5 ns time bin.

As shown in FIG. 2A, for a normal (e.g., a “dim” target), not all pulses from the emitter will be received. For the photons from the pulses that are received, the counts may be distributed across a range of bins (e.g., within a bin associated with a 100-105 ns subframe duration, a bin associated with a 105-110 ns subframe duration, a bin associated with a 110-115 ns subframe duration, etc.). Thus, condition (2) discussed herein is satisfied (i.e., the photon sensing is linear). The system may look at the distribution of the counts and determine the correct distance to the target (e.g., based on a 106.5 ns arrival time) with high resolution.

As shown in FIG. 2B, for a highly reflective target (e.g., a “retroreflector”), a strong signal may be received that results in a pile-up condition for the pixel. For pile-up, the strength of the signal causes the SPAD to frequently or always fire at the leading edge of the return signal pulse so that the majority or all of the detected return pulses land in the same bin. As a result, the majority or all of the detected photons will be received within a same bin due to the pile-up phenomenon. Thus, condition (2) (i.e., linear photon sensing) discussed herein is no longer satisfied. The system may be unable to determine the location of the target object with the appropriate level of detail because a distribution (e.g., a statistical distribution) of photon counts does not exist. The presence of the retroreflector, in conjunction with the nonlinearities of the photon arrivals that can occur due to the pile-up phenomenon and/or condition caused by the retroreflector, results in an effectively narrowed return signal.

FIG. 2C is a graph illustrating the phenomenon of pulse narrowing due to the sensor nonlinearities that can occur with a pile-up condition. In order to identify the effective pulse being injected to the system, a virtual histogram with very high time resolution has been used to construct the graph. As illustrated in FIG. 2C, the sensor nonlinearities that can be associated with photon pile-up may result in a measured signal 270 that is significantly narrowed with respect to the actual received signal 270, which may make determining an actual distance to a target difficult or impossible.

Some embodiments of the present disclosure include measurement systems and related control circuits that are configured to compensate for the pulse narrowing by delaying or offsetting (i.e., ‘dithering’) the timing of the strobe pulse relative to the timing of the emitter signal during the exposure time (e.g., within a measurement subframe), so that the effective return signal being measured by the use of a histogram is a linear superimposition of slightly displaced narrower pulses of the return signal. In some embodiments, this offset may be accomplished by maintaining a relatively constant timing with respect to the emitter and delaying and/or offsetting the activation of the detectors.

For example, to address the accuracy issue, some embodiments of the present disclosure implement measurement operations at a system level, whereby the timing offset of the strobe signal and/or strobe pulse relative to the laser pulse is varied with respect to the nominal histogram bin-edge. In other words, the delay between the start of the laser pulse (e.g., in response to the laser clock signal) and the beginning of the timing measurement (e.g., in response to the strobe signal/activation of a SPAD) may be dithered for a given strobe gate (which is repeated multiple times/for multiple emitter pulses per subframe).

In some embodiments, the variation may be carried out within the period of a single subframe and may cover a total offset of a single bin-time. By moving the leading edge of the return signal (e.g., a return signal pulse), additional range information can be recovered by examining the ratio of counts in adjacent bins. The offset spread can then be corrected in the off-chip processing stages, returning the original range information.

In some embodiments, the offset units may be in fractions of a bin-time. In some embodiments, the offset units may be in fractions of a pulse-width of the emitter. In some embodiments, the offset duration may be determined based on other considerations, such as the preferred effective range resolution of the system. In general, the effective timing resolution will be a function of the bin width used in the system and the offset duration. For example, the effective timing resolution of the system may be given as bin width (time)/number of offsets. For example, in a system that has a bin width of 8 ns and uses 8 offsets, the effective timing resolution may be 1 ns. In some embodiments, the offset may be controlled by changing the relationship between the internal bin clock reference (gclk, described further herein) and the external laser clock. In some embodiments, an on-chip delay-locked loop (DLL) may be used for this purpose as it has a typical resolution of 30 ps, allowing fine control over the offset steps.

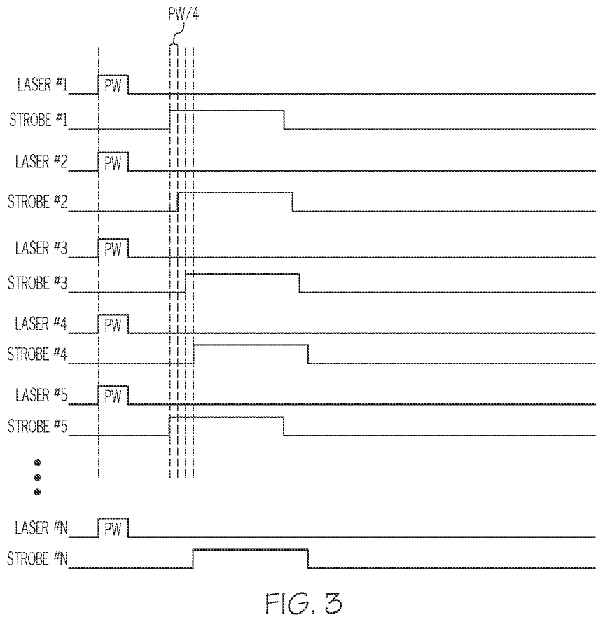

FIG. 3 is a schematic graph illustrating a laser clock vs. strobe pulse based on an example using four detection window offsets that are offset by one-quarter of the laser/emitter pulse length. FIG. 3 illustrates how the offsets might look from a timing perspective, where N is the number of emitter pulses in a full subframe.

Referring to FIG. 3, a first laser pulse (Laser #1) may be emitted having a particular pulse width PW. A first strobe activation signal (Strobe #1) may be activated at a first time for a first duration. The second laser pulse (Laser #2) may be emitted at a same relative time offset as the first laser pulse (Laser #1). A second strobe activation signal (Strobe #2) may be activated at a first offset (e.g., ¼ pulse width, PW/4) from the first time at which the first strobe activation signal (Strobe #1) was activated. The process may continue with subsequent activation windows (e.g., Strobe #2, Strobe #3, Strobe #N) being offset from one another by respective time offsets. Though only a single laser pulse per strobe window is illustrated in FIG. 3, this is for convenience of illustration. In some embodiments, a plurality of laser pulses and/or a plurality of strobe windows may be provided per offset.

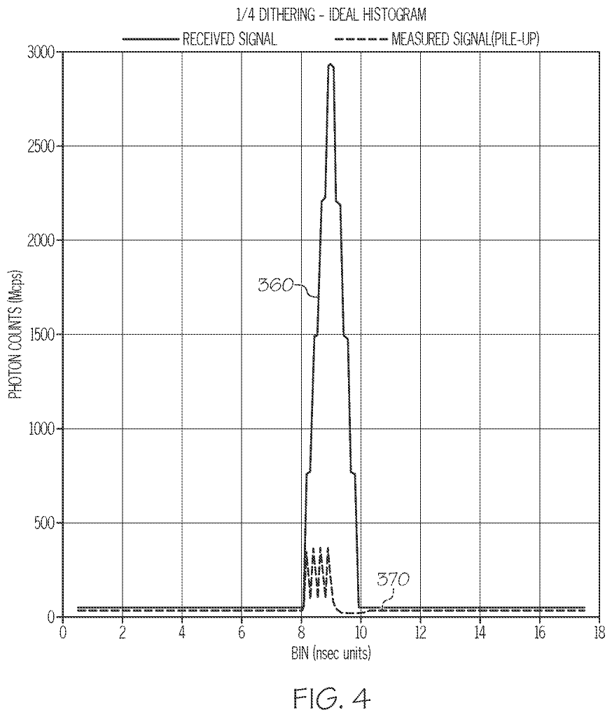

Using ¼ dithering, as illustrated by example in FIG. 3, may result in the receipt of return pulses that, when averaged, have a triangular-like average return pulse having double the original pulse length in case the nonlinearities are not triggered which turns into a rectangular-like average pulse having about the original pulse length when the nonlinearities are triggered. This is represented in FIG. 4. As illustrated in FIG. 4, the sensor nonlinearities that can be associated with photon pile-up may result in a measured signal 370. However, since the actual received signal 360 includes offset portions due to the dithered strobe activation signals described with respect to FIG. 3, the measured signal 370 may be distributed among a number of bins, as will be discussed further herein. This distribution may allow for accurate determination of a target's distance.

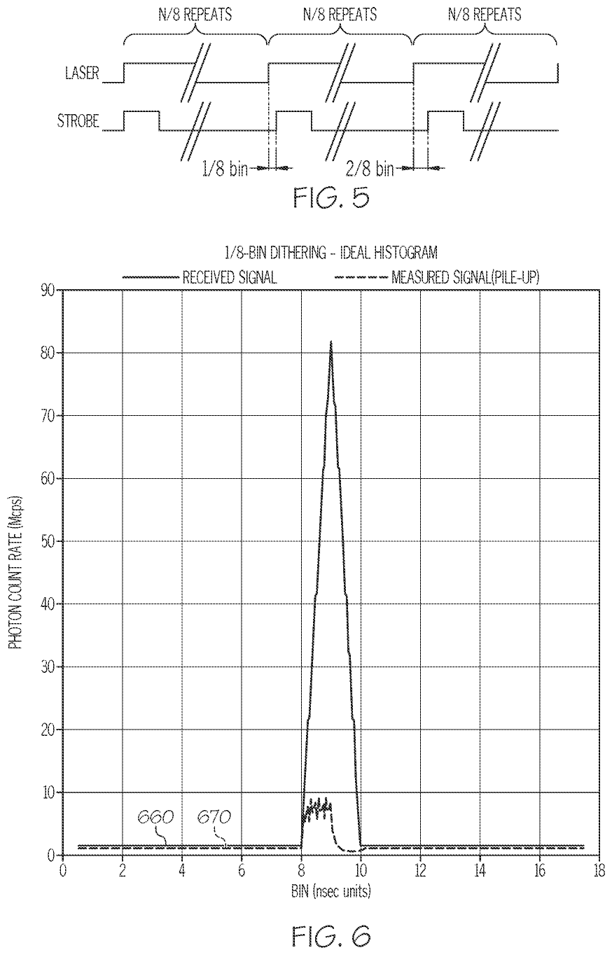

In some embodiments, the offset between strobe activation signals may be based on a width of the histogram bin. For example, 8 different offsets may be applied based on a bin width. In some embodiments, the offsets may be equally distributed across an 8 ns bin period. (For example, the offset may be 8 ns/8 or 1 ns.) Each offset may be applied for an eighth of the total number of emitter pulses per subframe. FIG. 5 is a schematic graph illustrating a laser clock vs. strobe pulse based on an example using eight offsets based on the bin duration.

FIG. 5 illustrates how the first three offsets might look from a timing perspective, where N is the number of emitter pulses in a full subframe. As illustrated in FIG. 5, a first strobe-pulse (e.g., a signal to trigger activation of the detector/SPAD) may be offset ⅛th of a bin width (e.g., 0.52 ns) from a second (e.g., a subsequent) strobe-pulse (or relative to the laser clock). Each strobe-pulse at a given offset may be repeated for a number of times. For example, for N laser pulses, N/8 strobe windows (strobe-pulses) may be provided with no offset, N/8 strobe windows may be provided with an offset of ⅛th of a bin, N/8 strobe windows may be provided with an offset of 2/8th of a bin, and so on. Though FIG. 5 illustrates a particular ordering of the various offsets within the subframe, it will be understood that this is merely an example, and other patterns may be used without deviating from the embodiments described herein. Since the counts for the various strobe windows of the subframe are accumulated to determine the overall photon counts for the subframe, the distributions of the various offsets of the strobe windows relative to the emitting laser within the subframe may occur in any combination.

The example above describes an embodiment in which each of the offsets is equal, but the present disclosure is not limited thereto. In some embodiments, the offsets may be varied (e.g., non-constant). For example, a first offset may be ⅛th (e.g., of a bin width or laser pulse) and a subsequent offset may be ⅜th (e.g., of a bin width or laser pulse). Other variations of the offsets may be utilized without deviating from the present disclosure.

If ⅛ (one-eighth) dithering is employed, the granularity of the dithering tends to disappear and the effective pulses tends to be triangular and rectangular, as illustrated in FIG. 6. As illustrated in FIG. 6, the use of offset strobe activation signals may result in a measured signal 770 that approximates a linear distribution despite the presence of the sensor nonlinearities that may be caused, for example, by reflective objects. The example illustrated in FIG. 6 in based on a theoretical infinitesimally small bin width, which allows the fine structure of the received signal 660 and measured signal 670 to be seen.

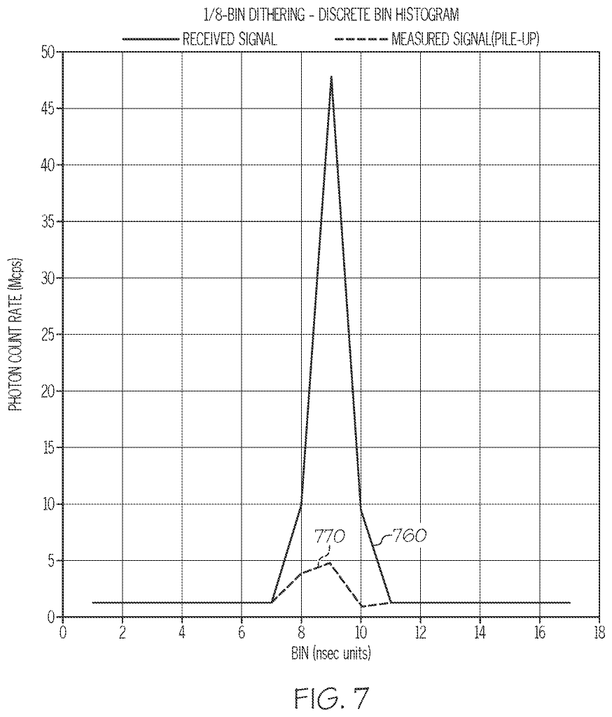

FIG. 7 illustrates an example in which the bins have a quantized (e.g., a discrete and/or finite) bin width. When represented using an actual and/or realistic bin width, as illustrated in FIG. 7, the signal pulse of the received signal 760 without pile-up is spread across three bins or across two bins in the measured signal 770 with pile-up, thus validating again condition (2) (e.g., linear photon sensing) and making the sensing capable of super-resolution by using a 3-bin interpolation.

That is, dithering a clock signal used to activate the detectors (e.g., by ⅛th of a bin width) within each subframe or across consecutive frames may result in a certain distribution of the strong echoes across a plurality (e.g., 2) bins. By looking at the ratio of photon counts across those bins the location of the target object, which may be a retroreflector, may be determined within a desired maximum error (e.g., 10 cm max error).

The 3-bin interpolation may be suitable for the above cases if the following are satisfied:

For a dim/far target (nonlinearities not triggered), the signal-to-noise ratio (SNR) has to be increased with respect to the non-dithered case; and

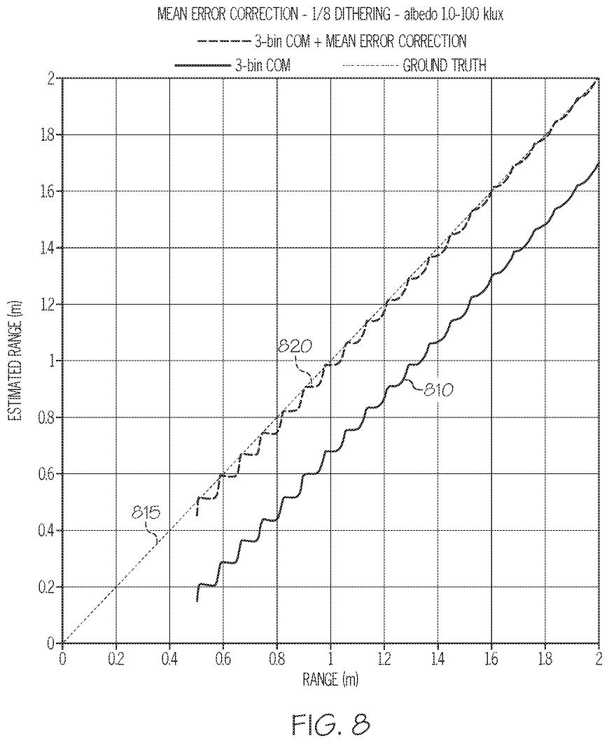

For a bright/close target (nonlinearities are triggered), condition (2) is still violated, so some further processing may be utilized. A lookup table (LUT) depending on the measured signal and background rate may be used in order to correct the displacement of the resulting rectangular pulse with respect to the originating rectangular pulse. FIG. 8 illustrates the application of a mean error correction to a detected signal. As illustrated in FIG. 8, an un-modified 3-bin center-of-mass (COM) calculation 810 may have an approximate 30 cm underestimation of the actual range of a target (the ground truth 815). By adding a correction factor (selected from a LUT) (e.g., to generate a calculated COM plus the error correction factor 820), the calculated range accuracy is improved to less than 10 cm.

In some embodiments, the calculated range may be determined by estimating the leading edge of the return signal based on a measured and/or estimate background level, as will be discussed further herein.

For some range detection systems where the emitter power is scaled with strobe range, it may be easy to increase the SNR for short or mid-range, dim targets with a slight increase in emitter power. For far targets, this may not be feasible without increasing peak emitter power. However, in this case, the dither scheme may not be required, and the system can revert to a non-dithered, 2-bin interpolation scheme.

FIGS. 3 to 7 illustrate how the strobe pulse may be varied with respect to the laser clock during a plurality of strobe windows within a subframe. However, the present disclosure is not limited thereto. In some embodiments, the same variations may be made, but the variations may be made during different frames. For example, a first frame may be captured with all of the offsets set to a first value (e.g., no offset). A second frame may then be captured with all of the offsets for the strobe windows of the frame set to a same offset that is different from the first value (e.g., one-eighth of the bin width). A third frame may then be captured with all of the offsets for the strobe windows of the frame set to a same offset (e.g., two-eighths of the bin width) different from that used in the second frame, and so on. After each frame, the contents of the histogram may be collected and counted to determine the distance to a particular target. After each of the offsets have been sampled (e.g., over eight frames), the various counts may be compared. It will be understood that the benefits in dealing with a retroreflector that are provided by offsetting the strobe windows with respect to the emitter over a number of frames may be the same as compared to performing the same offsets within a single subframe.

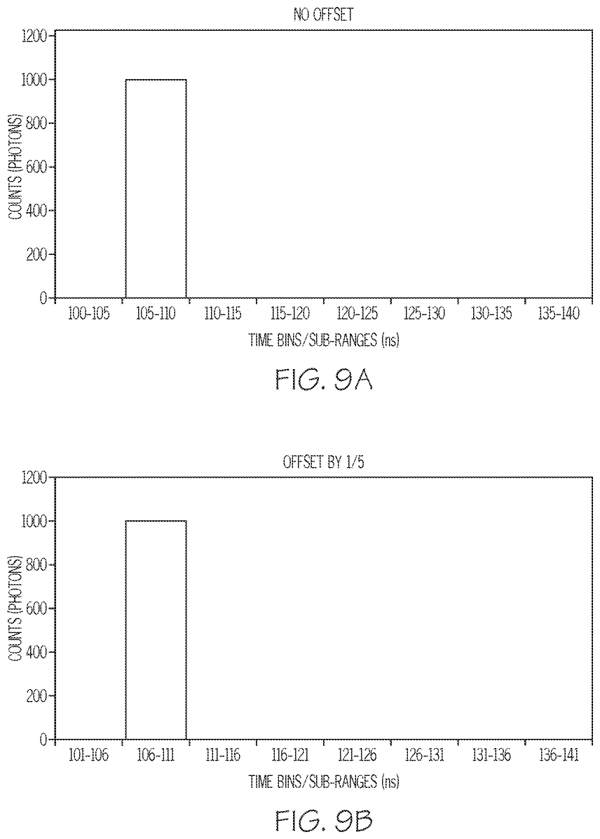

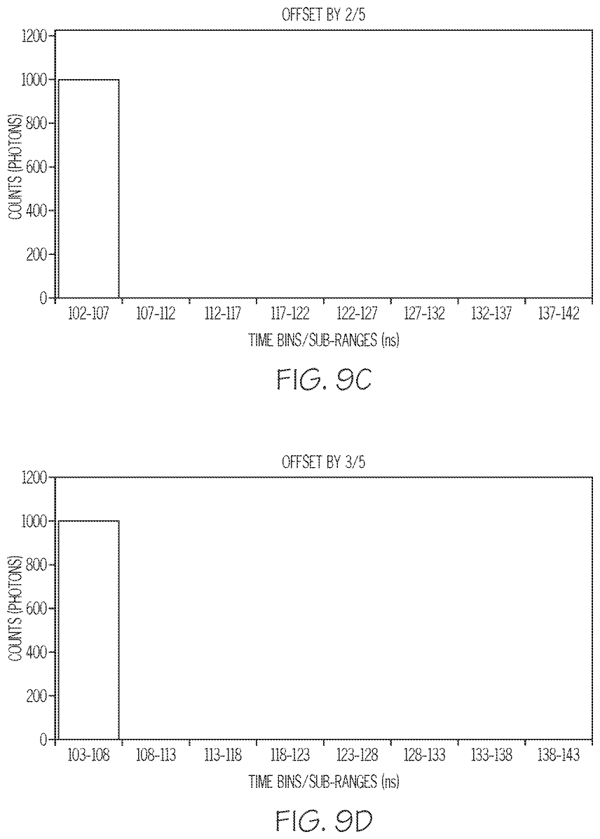

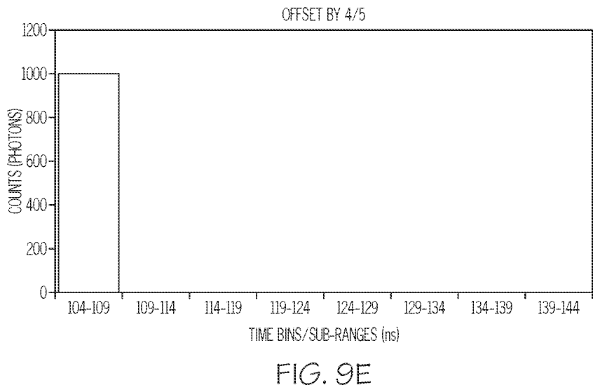

FIGS. 9A-9E are simplified graphs showing examples of adjusting offsets within a detection window to determine a location of a target, according to some embodiments of the present disclosure. FIGS. 9A to 9E illustrate an example of one strobe window within a frame that begins (nominally) at 100 ns and continues for 40 ns. As with FIGS. 2A and 2B, it is assumed that a highly-reflective target object is at a distance associated with an elapsed photon travel time of 106.5 ns. In contrast to the examples of FIGS. 3 to 7, the embodiments illustrated in FIGS. 9A to 9E describe an embodiment in which the offsets of the various strobe windows are varied across an entire frame. Thus, the histogram bin counts of FIGS. 9A to 9E represent the count of arrived photons for the given distance subrange across the entire frame. In these figures, it is assumed that 1000 pulses are emitted across the frame for this particular subrange. In some embodiments, this may be accomplished across a number of subframes (e.g., 10 subframes at 100 laser pulses each). FIGS. 9A to 9E respectively illustrate the counts across the entire frame for a particular distance subrange over which the detector (e.g., a SPAD) is activated by a strobe window. It will be understood that FIGS. 9A to 9E illustrate only a single distance subrange over which the strobe window is activated. The example of FIGS. 9A to 9E assumes a scheme where the detection window is offset by ⅕th of a bin width per frame. In FIGS. 9A to 9E, the bin width is 5 ns, so the offset per subframe is illustrated as 1 ns. These are merely examples and are not intended to limit the present disclosure.

Referring to FIG. 9A, a first frame may be captured with no offset from the laser emitter. The results of this initial frame will look similar to that of FIG. 2B. Namely, the majority or all of the photon counts will arrive within the 105-110 ns bin due to the presence of the retroreflector, which is the second bin in the distance subrange of the strobe window.

In FIG. 9B, the detection window is offset by ⅕th of the bin width, or 1 ns, in a subsequent frame. Thus, the detection starts at 101 ns and the starting time for each bin is offset by 1 ns from the corresponding subrange of the prior frame. In this frame, a majority or all of the photon counts will arrive within the 106-111 ns bin, which is the second bin in the distance subrange of the strobe window. In FIG. 9C, the example continues with the detection starting at 102 ns in a subsequent frame. In this subsequent frame, a majority or all of the photon counts will accumulate in the first bin, which covers from 102-107 ns bin of the strobe window. As illustrated in FIG. 9C, the bin location has shifted from the second bin to the first bin based on the increasing offset. Similarly, FIGS. 9D and 9E (each with increasing offsets) show a majority or all of the photon counts accumulating in the first bin, which includes the 103-108 ns and 104-109 ns bins respectively.

As illustrated in FIGS. 9A to 9E, the ratio of photons arriving in each of the bins can be compared to arrive at a more accurate estimate of the distance. This can be done via averaging of the photon counts or by a look-up table in some embodiments. In some embodiments, the estimate of the distance may be determined by detecting a leading edge of the summed or averaged photon counts, as discussed further herein. Increasing the number of offsets (e.g., to eight subframes, each offset by ⅛th of a bin duration) may increase the accuracy of the detection.

Though the prior discussion has utilized an example in which the dithering is accomplished by varying the start of a strobe window for a detector, it will be understood that the embodiments described herein are not limited thereto. In some embodiments, the dithering may be accomplished by maintaining a constant activation period with respect to the strobe windows (e.g., the strobe signals sent to the detectors) but instead varying a timing of the emitter activation signal/pulse. For example, the laser clock and/or other signal used to trigger the emitter pulse signal may be varied in a similar manner as described herein with respect to varying the strobe windows for the detectors. For example, using a ⅛th dithering operation as an example, for N laser pulses, N/8 laser pulses may be provided with no offset, N/8 laser pulses may be provided with an additional offset of ⅛th of a bin width of the strobe window from the initial laser pulse, N/8 laser pulses may be provided with an additional offset of 2/8th of a bin width of the strobe window, and so on. In some embodiments, the additional offsets may increase and/or vary a time between the emission of the laser pulse by the emitter and the detection by the detector during a strobe window. In some embodiments, adding the offset may involve activating the emitter by, for example, ⅛th of a bin width earlier than when no offset is used. Thus, the embodiments of the present disclosure may be accomplished by adjusting a time at which ones of the detectors are activated to detect photons and/or adjusting a time at which the emitters are configured to emit a signal pulse.

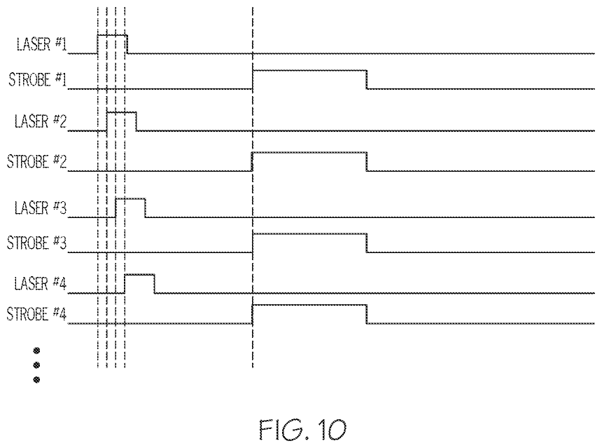

FIG. 10 is a schematic graph illustrating a laser activation signal vs. strobe activation signal based on an example using four laser pulse offsets that are each offset by one-quarter pulse width relative to one another. Referring to FIG. 10, an activation signal may be provided to an emitter to emit a first laser pulse (Laser #1) having a particular pulse width. The first laser pulse may be emitted with no relative offset. The strobe activation signal (Strobe #1) may be activated at a first time for a first duration. The second laser pulse (Laser #2) may be offset at a first offset (in this example, ¼ of the laser pulse) from the first laser pulse. The offset may refer to, for example, a relative offset between the time or frequency of activation of the first laser pulse and activation of the second pulse. In some embodiments, the offset may be relative to a subsequent strobe activation signal sent to the detectors. For example, the strobe signal sent to the detectors may be sent at a particular frequency and/or period that is relatively constant, and a signal sent to the emitters may be varied with respect to the activation signal of the strobe. In some embodiments, the offset may be relative to a start of a subframe. For example, the control circuit may provide a laser activation signal that sends the first laser pulse at a first time with respect to the start of the subframe and a second laser pulse may be sent at an offset from that first time with respect to the start of the subframe.

The strobe activation signal (Strobe #2) associated with the second laser pulse may be activated at a same relative time (e.g., from the start of the subframe) and/or frequency as the first activation signal (Strobe #1). That is, the offset discussed herein may be generated by the offset in the laser emission rather than the offset in the activation of the detectors. The offsetting of the laser emission may continue through a plurality of offsets. In FIG. 10, the offset is shown as a portion of the pulse-width of the laser for ease of illustration. However, it will be understood that other, more granular offsets may be used. For example, the offsets may be based off of a bin width (e.g., a fraction of a bin width) or a predetermined effective range resolution of the system rather than the laser pulse width.

The offsets generated by variation of the emitter may be utilized in similar ways as previously discussed. For example, the emission of the optical signals may be dithered for a plurality of subframes of a frame. In some embodiments, a different offset for the emitter may be utilized for different frames. That is to say that a first offset of the emitter may be used for a first frame, a second offset for a second frame, and so on.

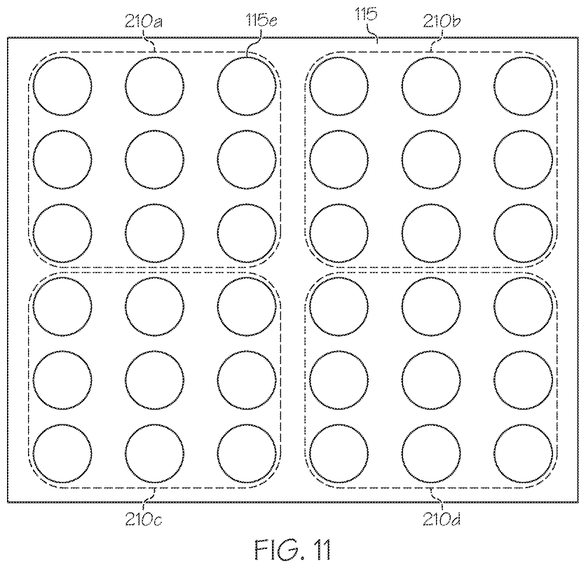

ToF systems that utilize dithering with the laser emitters may be used to provide additional advantages in some embodiments. For example, in some embodiment the offsets in the laser may be distributed across a plurality of emitters of an emitter array. FIG. 11 illustrates an emitter array configured to incorporate dithering, according to some embodiments of the present disclosure.

Referring to FIG. 11, an emitter array 115 may incorporate a plurality of emitters 115e. The plurality of emitters 115e may be arranged in a plurality of groups 210a, 210b, 210c, 210d (also referred to as groups 210). Though four groups 210 are illustrated in FIG. 11, the number of groups 210, as well as the number of emitters 115e in each group 210, is merely an example and not intended to limit the disclosure. The emitters 115e in the groups 210 may be configured to illuminate a field of view that is substantially the same. That is to say that the optical signals from a first of the groups (e.g., group 210a) may emit optical signals that cover a field of view that is substantially the same as another of the groups (e.g., group 210d).

The activation of the emitters 115e of the emitter array 115 may be controlled by a control circuit, such as control circuit 105 of FIGS. 1A and 1B. The control circuit may be configured to separately control the emission of the optical signals from each of the groups 210. For example, the control circuit may be configured to control a first group 210a of the emitter array 115 to activate at a first time and to control a first group 210b of the emitter array 115 to activate at a second time that is offset from the first time.

For example, using a ¼ dithering approach with N laser pulses within a subframe, a first activation signal to generate N/4 laser pulses may be provided with no offset to the first group 210a during the subframe, a second activation signal to generate N/4 laser pulses may be provided with an additional offset of ¼th of a bin width from the first activation signal to the second group 210b during the subframe, a third activation signal to generate N/4 laser pulses may be provided with an additional offset of 2/4th of a bin width to the third group 210c during the subframe, and a fourth activation signal to generate N/4 laser pulses may be provided with an additional offset of ¾th of a bin width to the fourth group 210d during the subframe. For example, if the ToF system uses a bin width of 8 ns, each of the offsets may be 2 ns. Thus, the first group 210a may be activated at an offset of 0 ns (e.g., no offset), the second group 210b may be activated at an offset of 2 ns, the third group 210c may be activated at an offset of 4 ns, and the third group 210d may be activated at an offset of 6 ns.

A plurality of detectors may detect optical signals resulting from the emission by each of the groups 210. Because the optical signals emitted by the groups 210 were offset relative to one another, the optical signals received by the detectors may be similarly offset. The counts of the photons from the optical signals that are received by the detectors may be accumulated in the bins of a histogram as discussed herein. At the end of the N laser pulses, a readout of the bins may be performed at the end of the subframe to collect the photon counts from the detectors. A distance to the object may be determined based on the collected counts from each of the subframes of a frame, including error correction where warranted, as discussed herein.

The use of four offsets in FIG. 11 is merely an example and is not intended to limit the disclosure. In some embodiments, other quantities of durations may be used. In some embodiments, the number of offsets may equal the number of groups 210, but the present disclosure is not limited thereto. In some embodiments, the number of groups 210 may be different than the number of offsets.

In addition to improving a detection capability of the ToF system, the embodiment illustrated with respect to FIG. 11 may have additional advantages. By varying a time at which the emitters 115e are activated, a peak power of the system may be reduced. In a traditional system, all N emitters 115e may be activated simultaneously, leading to a peak power usage based on the power usage of all N emitters 115e. In embodiments according to the present disclosure, the different groups 210 may all be activated in a given subframe, but may be activated at different times. Therefore, though the total/average power of the system may be unchanged, a peak power may be reduced. This may result, for example, in a reduction in current amplitudes (e.g., current spikes) within the ToF system.

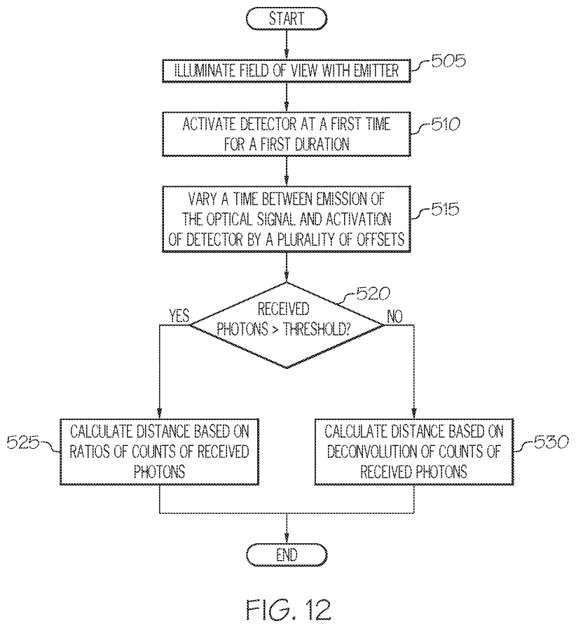

FIG. 12 is a flowchart of a method for a LIDAR system to calculate a distance to a target object according to some embodiments of the present disclosure. Referring to FIG. 12, the method may begin at step 505 in which the field of view of the LIDAR system may be illuminated using one or more emitters, such as emitters 115e described with respect to FIG. 1A. In some embodiments, the emitters may be activated a plurality of times for a given subframe.

The method may continue in step 510 in which a detector is activated for a first time for a first duration. The detector may be, for example, one or more of the detectors 110d described with respect to FIG. 1A. In some embodiments, the detector may be activated via a signal such as a strobe signal, which may be provided to the detector by a control circuit, such as control circuit 105 described with respect to FIGS. 1A and 1B. The duration for which the detector is activated may be a strobe window. The strobe window may constitute a portion, e.g., a subframe, of a target acquisition frame. The first time may be a time after the activation of the emitter that corresponds to a distance that a photon may travel from the emitter, reflect off the target object, and return to the detector. Photon counts received at the detector may be accumulated, such as in bins of a histogram. The process of illuminating the field of view by the emitter and activating the detector at the first time may be repeated a plurality of times to collect photon counts associated with the first time and the first duration. The photon counts may correspond to the number of photons detected by the detector at various time points within the first duration.

In step 515, a time between the emission of the optical signal by the emitter and activation of the detector may be varied by a plurality of offsets. Offsetting the detection may be accomplished by more than one method.

For example, in some embodiments, the detector may be activated for the first duration at a time that is offset from the first time (or offset from the timing of the emitter activation). In other words, the detector may be activated for the same initial duration, but the activation may start at some point that is later than (offset from) the first time. In some embodiments, the offset may be a subset of the time duration of a single histogram bin. For example, the offset duration may be ¼th, ⅕th, ⅙th, ⅛th, or other fraction of the bin width (in ns). In some embodiments, the offset duration may be based on a fraction of the pulse width of the emitter. It will be understood that these offsets are only examples, and that other offsets may be used without departing from the scope of the disclosure. In some embodiments, a plurality of different offsets may be used. For example, the detector may be activated a number of times at a first offset, a number of times at a second offset, a number of times at a third offset, and so on. Each activation of the detector may correspond to a prior illumination of the field of view of the emitter. The photon counts associated with each of the activation periods may be saved and associated with respective histogram bins.

As another example, in some embodiments, the illumination of the field of view by the emitter may be offset between different activations of the emitter. For example, the activation of emitter in step 505 may be performed at a first time with respect to a subsequent activation of the detector. Next, the emitter may be activated at a second time that is offset from the first time (e.g., with respect to the subsequent activation of the detector) by a particular time offset. The changing of the timing of the activation of the emitter with respect to the subsequent activation of the detector may offset the detection of the photons by the detector.

In some embodiments, step 515 may be performed across a single frame. For example, the detector may be activated at the plurality of offsets and/or the emitter may be activated at a plurality of offsets within various subframes and/or distance subranges of a single target acquisition frame. In other words, a first plurality of offsets may be used for a first plurality of strobe windows and/or emitter activations associated with a first subframe and/or distance subrange and a corresponding first photon count may be collected (e.g., by a readout operation). In some embodiments, a second plurality of offsets may be used for a second plurality of strobe windows and/or emitter activations associated with the subframe and/or distance subrange, and a corresponding second photon count may be collected (e.g., by a readout operation). The first and second photon counts may be accumulated as part of the total photon count for the acquisition frame or subframe, which may be used to calculate the distance to the target object.

In some embodiments, step 515 may be performed across multiple frames. For example, the detector and/or emitters may be activated at a first offset for one or more subframes and/or distance subranges of a target acquisition frame and corresponding first photon counts may be collected across the full frame. A second offset may be used for one or more subframes and/or distance subranges of a second target acquisition frame, and corresponding second photon counts may be collected. The first and second photon counts may be respectively accumulated during each acquisition frame, and the counts from both acquisition frames may be used to determine the distance to the target object.

In step 520, the number of photon counts that were received may be analyzed. In some embodiments, this analysis may be preceded by a determination of a background photon count (e.g., a photon count associated with non-correlated photons such as from the background and/or ambient environment), and an adjustment of the photon counts to be processed based on the determined background photon count. For example, the LIDAR system and/or a control circuit thereof may look at the total number of photons received for the various activations of the detectors. When a number of photons that are received is similar to the number of times the emitter was activated, it may signal that a highly reflective target is present. For example, the LIDAR system may determine if the number of photons received is within 90% of the number of laser pulses (or other types of light emission) that were activated. Thus, the count of received photons may be compared to a predetermined threshold. If the count of received photons is greater than the threshold (step 525), the lidar system may assume that a highly-reflective target (e.g., a pile-up condition) is present and may calculate the distance to the target based on a ratio of the received photons per offset bin. If the count of received photons is less than or equal to the threshold (step 530), the lidar system may assume that no highly-reflective target is present and may calculate the distance to the target based on the background-subtracted received photon counts. For example, an interpolation of the photon counts may determine the distance to the target object by utilizing the distribution of the photon counts and the known information related to the bin offsets to determine the distance to the target. For example, the step 530 may calculate the distance by adjusting the conventional calculation techniques to accommodate the offsets in the histogram bin start times.

Some embodiments described herein provide a 3D direct-ToF imaging system using temporal sub-sampling to reduce device size and system complexity while achieving high temporal resolutions. In some embodiments, a method for improving the temporal resolution of such systems may include offsetting the start and end times of the measurement periods (bins) of times of arrival of photons with reference to another timing signal, such as the start of an illuminating laser pulse (aka dithering). As previously described, this scheme is especially beneficial in cases of signal pile-up where the measured timing histogram is distorted with respect to the real photon arrival-times statistics. Dithering, in effect, stretches the pulse over more bins, thereby making it possible to determine the peak position with a resolution better than the bin width, even in cases where the collected distribution is compressed due to pile-up.

In some of the previously described embodiments, a given strobe signal was provided to a plurality of detectors in a pixel responsive to a first laser pulse, and a subsequent dithered strobe signal (e.g., a subsequent strobe signal having a leading edge offset from that of the prior strobe signal by a fraction of a bin width or laser pulse) was provided to the plurality of detectors in the pixel responsive to a second laser pulse. Such a dithering scheme can introduce a number of challenges. For example, such a dithering scheme may utilize a higher number of laser pulses versus a non-dithered scheme in order to maintain the same signal-to-background ratio, since photon counts (e.g., by the recipient detectors) are now distributed across more gross time bins, while the background count per gross time bins remains the same regardless of whether dithering is used or not. A larger number of pulses may translate to either a longer acquisition time and/or to higher average power per acquisition, both of which may be undesirable in some applications.

In some embodiments, each detector generates a series of detections which may then be used to create a time-of-flight histogram. In some additional embodiments, the signal from the detectors of a pixel may be used to create multiple histograms in response to a single laser pulse, each of which is offset by a fraction of a bin and/or pulse width from the histograms of the other detectors. Thus, in some embodiments, rather than generating the offset histograms sequentially within a subframe in response to multiple laser pulses (one histogram per laser pulse), the multiple histograms can be acquired simultaneously in response to a single laser pulse.

In some embodiments, the multiple histograms may be stored across multiple memory arrays. In terms of implementation, one or more low-jitter inverters or buffers may be used to isolate the detector's (e.g., the SPAD's) junction capacitance from the larger capacitance of the multiple memory arrays (which may be larger than the capacitance of a single memory array).

In some embodiments, the outputs of a plurality of memory arrays per pixel may be provided to generate data utilized for populating a 3D point cloud. In some embodiments, the contents of the memory arrays may be processed, for example using in-pixel circuitry to generate a consolidated output. For example, the contents of the memory arrays may be added, subtracted, multiplied, and/or divided to create a processed histogram.

A configuration incorporating a plurality of detectors, each associated with a strobe window offset by 1/n-th of a time bin (and/or a clock signal associated with the strobe window that controls each time bin integrating photons in the associated histogram that is offset by 1/n-th of a time bin) may have a reduced angular resolution, because the photon counts from n of the detectors may be combined to generate a histogram that was previously being generated by a single detector. In many lidar applications, the angular resolution required in short ranges is less fine than in long ranges, because the lateral extent of an object subtended by a solid angle as viewed by the lidar system is proportional to its distance from the lidar. For example, in ranges of 0-50 m, a lidar system may be desired to have an angular resolution of 0.5×0.5 degree per pixel whereas in ranges of 50 m-300 m the system may be desired to have an angular resolution of 0.1×0.1 degree per pixel. It should be noted that pile-up due to a saturating signal level is more likely to happen in targets which are closer to the lidar than those that are farther away. Thus, dithering may be of greater benefit for closer objects, and a solution that has a manageable reduction in angular resolution may be less detrimental at such shorter ranges.

In some embodiments, a detector array (e.g., a SPAD array) may be divided into sub-units (e.g., a macropixel), each with p by q detectors. In some embodiments and/or situations, multiple range strobes may be utilized and the lidar system may use spatial dithering at close ranges (and process macropixel histograms in aggregate) and not use spatial dithering in long ranges (and process pixels' histograms individually). In some embodiments and/or situations, the lidar system may use the timing signals for spatial dithering in all strobe windows and process macropixels at strobe windows associated with shorter ranges and individual pixels at strobe windows associated with longer ranges. In other embodiments, a single strobe window may be used and then only the second scenario above may apply.

For example, during acquisition periods (e.g., strobe windows) corresponding to fine-angular-resolution acquisition, such as at farther ranges, each detector of the array may output a histogram and the timing signal to all of the detectors (and thus to all of the memory banks) that may be the same. However, the embodiments described herein are not limited thereto. In some embodiments, the 1/nth period clock or strobe offset may be used even at long range and the return signal may be processed to compensate the estimated depth for the known offset. This may be less complex to implement and may have the desirable effect of distributing temporally the power draw from the receiver pixel array electronics.

During the acquisition periods (e.g., strobe windows) corresponding to gross-spatial-resolution acquisition, such as at closer ranges that may also be more prone to pile up, the output of only one detector out of each sub-unit may be acquired. In some embodiments, the detectors which are not used for acquisition in a given strobe window are not charged or activated. The acquired output is routed to all memory banks in the sub-unit, each of which is offset in timing from its adjacent bank, and an arithmetic operation may be performed to increment a count based on the event time, thus recording a set of dithered histograms for this pixel.

In some embodiments, in the gross-resolution strobe, the outputs of all detectors are routed to their respective memory cells, based on their time, and an arithmetic operation may be performed to increment the arrival counts for the appropriate bin based on the signals from all the detectors, thus recording a set of dithered histograms for this sub-unit. A processing circuit identifies whether a signal echo has been acquired and computes the distance to the target based on the one or more histograms collected.

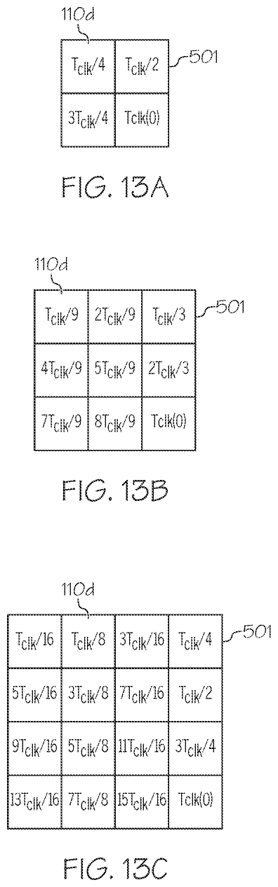

For example, some embodiments herein include a solution in which a plurality of clocked histogramming detectors are arranged in macropixel groups. FIGS. 13A to 13C illustrate examples of various macropixel configurations according to some embodiments of the present disclosure. FIG. 13A is a schematic illustration of a macropixel 501 including a plurality of individual detectors 110d. In some embodiments, the detectors 110d may be SPADs. FIG. 13A illustrates a 2×2 macropixel configuration including 4 detectors. As discussed herein, the activation signal (e.g., a strobe activation signal defining the strobe window) that is applied to each of the detectors 110d may be individually dithered. In some embodiments, the dithering may be based on the pulse width of the emitter (e.g., a laser pulse) or the bin-width of the histogram used by the detection computation system.

For example, a time-offset clock signal may be distributed to each detector 110d in the macropixel 501. For example, each clock may be offset by an amount T_{offset} that is given by the equation:

T_{offset}(i)=i*T_{clk}/n

where T_{clk} is a global bin clock period, n is number of the detectors 110d in the macropixel 501, and i is an index of the detector 110d within the macropixel 501. Though TA is given as corresponding to the global bin clock period, in some embodiments Tock may be based on a duration (width) of a laser pulse used by the lidar emitter.

For example, in a system that has a bin width of 8 ns and in which dithering is performed based on four offsets (n=4), a macropixel 501 may be configured of 4 detectors 110d, each receiving a strobe signal offset from the others by 2 ns (8/n). Such a configuration is illustrated in FIG. 13A. For example, a first of the detectors 110d may receive a strobe signal that is offset (dithered) by Tclk/4, a second of the detectors 110d may receive a strobe signal that is offset (dithered) by Tclk/2, a third of the detectors 110d may receive a strobe signal that is offset (dithered) by 3*Tclk/4, and a fourth of the detectors 110d may receive a strobe signal that is offset (dithered) by Tclk (which is also effectively an offset of 0 from the Tclk signal). The offset provided to each of the individual detectors 110d may be similar to those offsets provided to all of the detectors in the previously described embodiments. However, in the macropixel 501 of FIG. 13A, the different offsets may be provided to the detectors 110d in response to a single emitter pulse and the photons detected by detectors 110d may be combined as previously described to determine the range to a target object.

Though FIG. 13A illustrates an embodiment in which four detectors 110d are utilized, the present disclosure is not limited to such a configuration. More generally, a macropixel 501 may be composed of n detectors 110d, and each of the detectors 110d may receive an activation signal (e.g., a strobe activation signal defining a strobe window) that is offset by 1/n of a bin width (or laser pulse width) from others of the detectors 110d. FIGS. 13B and 13C illustrate embodiments of macropixels 501 incorporating nine and sixteen detectors 110d having offsets of T_{clk}/9 and T_{clk}/16, respectively.

As discussed herein, the use of dithering can be especially beneficial at shorter ranges. The reduction in angular resolution at closer ranges may be more acceptable (e.g., because a similarly-sized object will span a wider solid angle at shorter range than it would at a longer range) such that spatial dithering is less problematic for nearer targets. At longer ranges, the lidar system may determine the distance to the target using mechanisms that take the dithered offset into account. For example, at long (or longer) ranges (e.g., ranges beyond one-third of the maximum range of the system), the counts from each of the individual detectors 110d may be used as part of a center of mass method (CMM) calculation around the histogram peak (T_{CMM}) that compensates for the offset (T_{offset}). For example, the range may be calculated based on (T_{CMM}−T_{offset}(i))*c/2. CMM calculations are described, for example, in U.S. patent application Ser. No. 16/746,218, filed Jan. 17, 2020, entitled “DIGITAL PIXELS AND OPERATING METHODS THEREOF,” the contents of which are incorporated herein by reference.

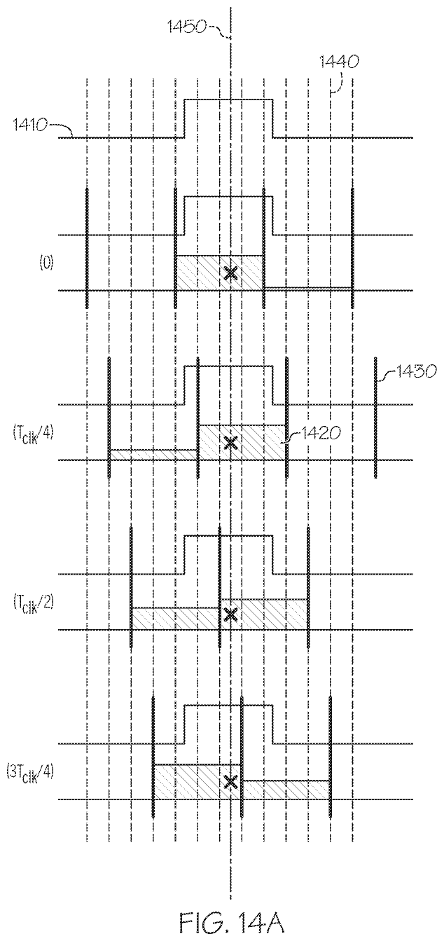

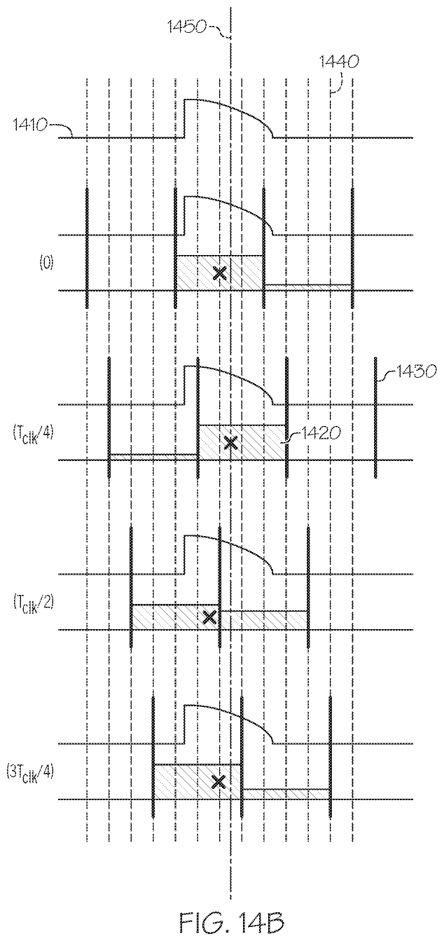

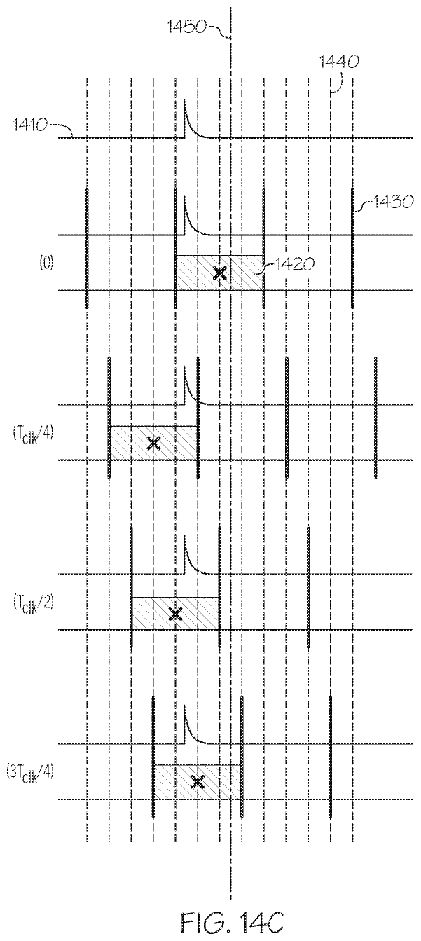

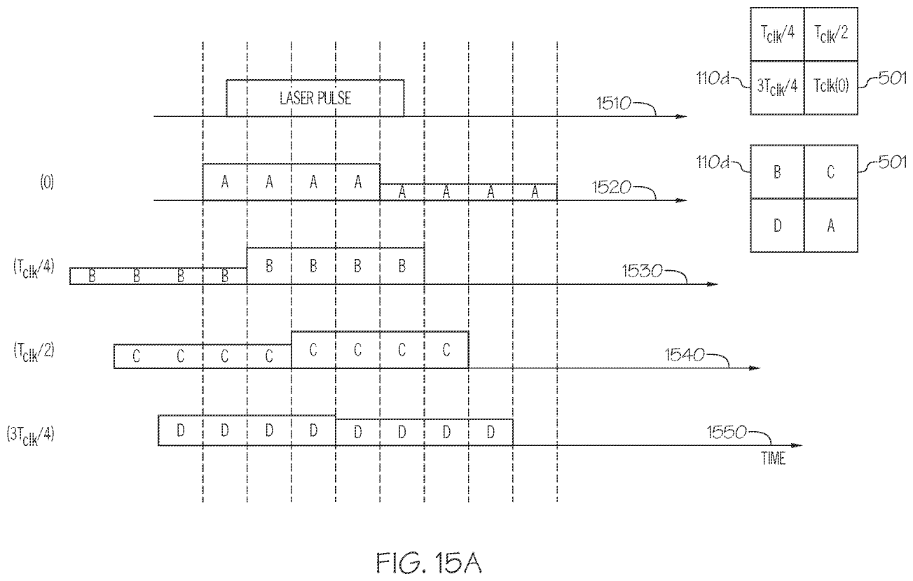

FIGS. 14A to 14C are schematic graphs illustrating methods of utilizing offset detectors in determining a range to a target, according to some embodiments of the present disclosure. FIG. 14A illustrates the allocation of photon counts (illustrated by the shaded blocks 1420) into various bins (illustrated by the solid vertical lines 1430) for a longer-range center of mass calculation in a macropixel in which the strobe windows to each of the detectors of the macropixel are offset (illustrated by the dashed vertical lines 1440) from one another. As illustrated in FIG. 14A, the strobe windows may be offset from one another, but portions of the various strobe windows may overlap in time. The example of FIG. 14A utilizes four detectors in a configuration similar to that of FIG. 13A. In FIG. 14A, the return signal of the lidar system is illustrated as the top signal 1410, and the bin counts of each detector (illustrated as being offset by 0, Tclk/4, Tclk/2, and 3*Tclk/4) are illustrated below the return signal at their respective offsets. An ‘X’ symbol is used to illustrate where a theoretical center-of-mass 1450 would be calculated for a given histogram. As illustrated in FIG. 14A, the return signal is relatively well distributed. As such, the photon counts are distributed across each of the detectors histograms and pile-up has not occurred. The histogram for each detector may be separately used (e.g., without combination) to estimate the range to the target.

At shorter ranges, the lidar system may determine the distance to the target using mechanisms that combine the dithered results of the plurality of detectors 110d of the macropixel 501. For example, at short (or shorter) ranges (e.g., less than one-third of the maximum range of the system), the counts from each of the individual detectors 110d may be combined and analyzed to look for a leading edge of the return signal of the emitter with resolution Tclk/n, where n is the number of detectors 110d.

FIG. 14B illustrates the allocation of photon counts into various bins for a center of mass calculation in a macropixel in which each of the detectors of the macropixel are offset from one another. A description of elements of FIG. 14B that are identical to those of FIG. 14A will be omitted for brevity. The example of FIG. 14B utilizes four detectors in a configuration similar to that of FIG. 13A. In FIG. 14B, partial pile-up has occurred which has resulted in a return signal that is statistically distributed differently than the actual photon arrival statistics. In a conventional system, the partial pile-up may result in a loss of a count of photons at the trailing edge of the return signal, making it difficult to determine the range to the target.

However, as illustrated in FIG. 14B, the use of offset bins 1430 allows for the received counts to provide more precise information about the earliest detection of photons at the leading edge of the return signal distributed across individual detectors of the macropixel. Comparing the histograms from each of the detectors to one another, it can be seen that the use of the T_{clk}/n offset has resulted in a more distributed set of histograms, which may be combined, as will be discussed further, to more accurately estimate the distance to the target.

FIG. 14C further illustrates a similar macropixel configuration having an even sharper pile-up phenomenon. A description of elements of FIG. 14C that are identical to those of FIG. 14A will be omitted for brevity. In a similar manner as illustrated with FIG. 14B, the use of the T_{clk}/n offset has provided a distributed set of histogram bins 1430 that may be combined to provide additional information to determine an improved estimate to the distance to the target.

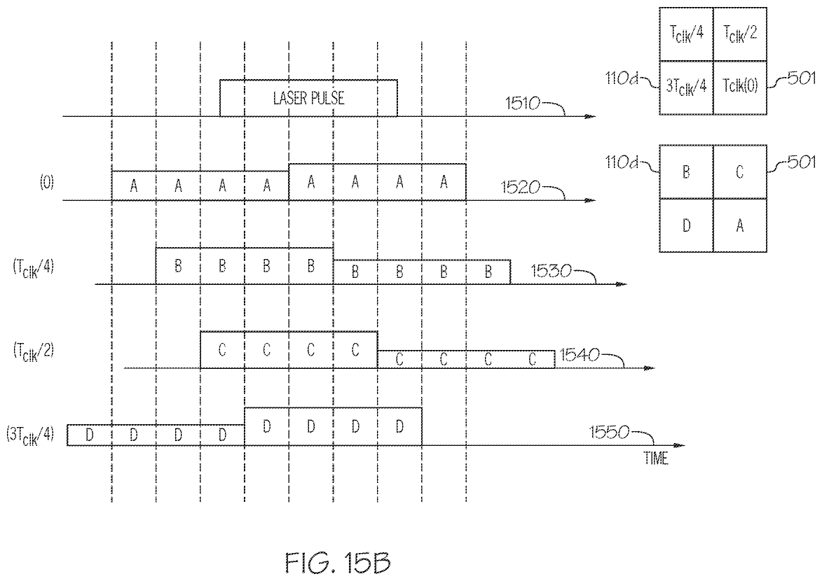

FIGS. 15A and 15B are graphs illustrating methods of combining histograms from offset detectors 110d in a macropixel 501, according to some embodiments of the present disclosure. In FIGS. 15A and 15B, the return signal of the lidar system is illustrated as the top signal 1510, and the bin counts of each detector 110d, illustrated as being offset by 0 (1520), Tclk/4 (1530), Tclk/2 (1540), and 3*Tclk/4 (1550), are illustrated below the return signal at their respective offsets. FIGS. 15A and 15B illustrate how the counts in the various offset bins will vary based on where the return signal lies with respect to the various detectors 110d.

In FIGS. 15A and 15B, the relative size of the photon counts is shown based on the size (height) of the particular bins. Each of the rectangles are intended to represent a particular strobe window with a plurality of bins therein (in this example four bins are shown per strobe window). FIG. 15A shows an example in which the return signal arrives relatively early with respect to the beginning of the activation cycle (strobe window) of the detector having the first offset, or detector A (shown as offset 0, which is equivalent to an offset of Tclk). As shown in FIG. 15A, the set of bins for the first strobe window of detector A will receive the bulk of the photon counts, with the subsequent strobe window receiving fewer photon counts. In contrast, because of the strobe window offset, the detector 110d with the Tclk/4 offset (detector B) may see fewer photon counts in an initial strobe window that detects the return signal but may have more photon counts in a subsequent strobe window. Detectors C and D may have similar variations in their photon counts depending on the positioning of the start times of the bins based on the respective offsets.

FIG. 15B shows an example in which the return signal arrives relatively late with respect to the beginning of the activation cycle of the detector having the first offset, or detector A (shown as offset 0, which is equivalent to an offset of Tclk). As shown in FIG. 15B, the set of bins for the first strobe window of detector A will receive fewer photon counts, with the subsequent strobe window detecting a larger number of photons. In contrast, because of the strobe window offset, the detector 110d with the Tclk/4 offset (detector B) may see more photon counts in an initial strobe window that detects the return signal but may have fewer photon counts in a subsequent strobe window. Detectors C and D may have similar variations in their photon counts depending on the positioning of the start times of the bins based on the respective offsets.

As illustrated in FIGS. 15A and 15B, each detector 110d of the macropixel 501 will arrange their photon counts slightly differently in the histogram bins due to the Tclk/n offset.

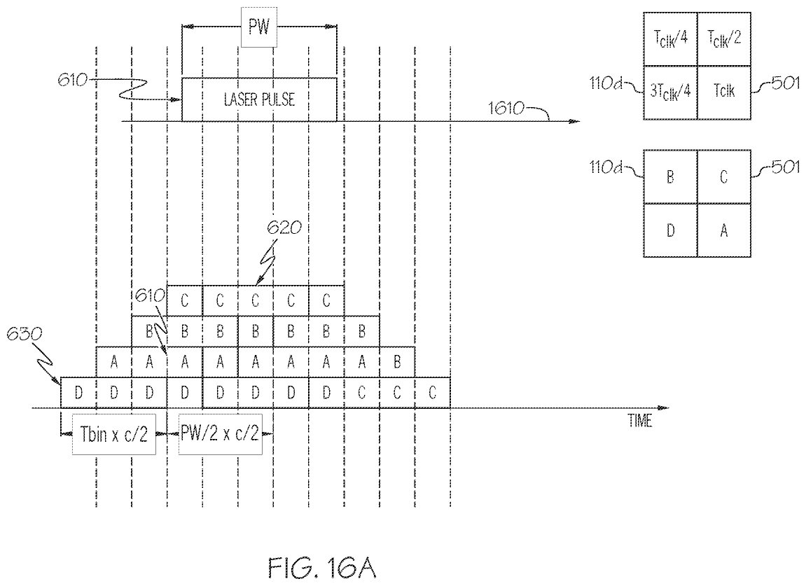

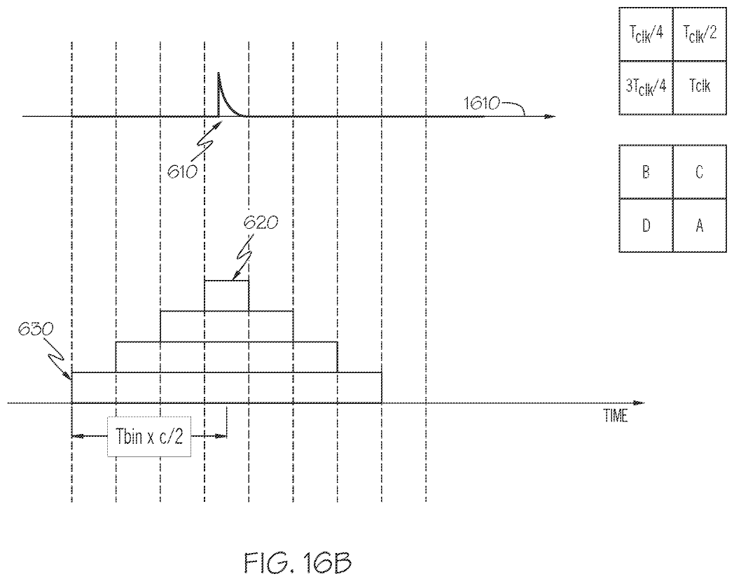

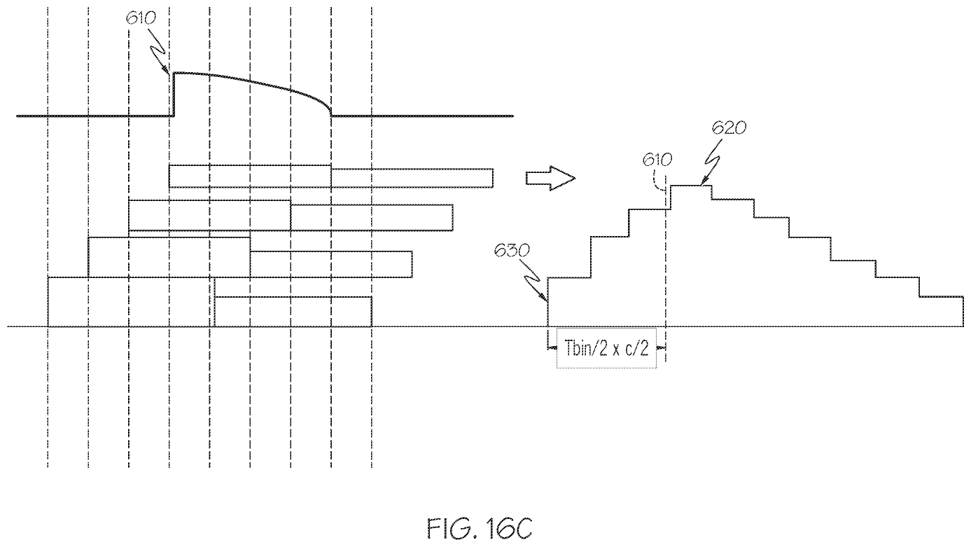

FIGS. 16A to 16C are schematic diagrams illustrating a method for determining the leading edge of the return pulse according to some embodiments of the present disclosure. The method may include summing the time-aligned bins of the histograms of the plurality of detectors 110d of the macropixel 501. As used herein, time-aligned bins refer to bins from different histograms (e.g., different histograms from different detectors) that begin at a substantially the same time within a particular strobe window. For example, due to the time offsets that may be applied to a first strobe window relative to a second strobe window, as described herein, a first bin of a first histogram of the first strobe window may be time-aligned with a second bin of a second histogram of the second strobe window. FIG. 16A illustrates an embodiment in which the summed histograms are applied to a return signal that is relatively well distributed. FIG. 16A illustrates an operation of summing the photon counts illustrated in FIG. 15B. Referring to FIG. 16A, the return signal 1610 of the laser pulse (having a pulse width PW) is shown at the top of the figure. At the bottom of the figure, the summed figures of the various histograms are shown. For example, if a particular time slice (e.g., associated with a series of time-aligned histogram bins) is associated with bins having counts for both the A detector and the B detector (each having different offsets from one another), the two counts may be combined in a histogram bin. FIG. 16A shows an example configuration for how the photon counts for the various detectors may be arranged/combined. The method may sum time-aligned histograms of the N detectors 110d of the macropixel 501 of FIG. 15B. For a macropixel 501 with N detectors 110d, this results in an N times increase in number of bins of resulting histogram.

Part of determining the estimated range of the target may involve determining the leading edge 610 of the return signal. In some embodiments, this may be accomplished by determining the peak 620 and/or the rising edge 630 of the accumulated photon counts (e.g., the accumulation of the counts within the histograms of the detectors of the macropixel). The leading edge 610 of the return signal may be separated from the peak 620 of the histogram by (PW/2)*(c/2), where PW is the pulse width of the emitter signal and c is the speed of light. The leading edge 610 of the return signal may be separated (e.g., in terms of distance) from the rising edge 630 of the histogram by (Tbin)*(c/2), where Tbin is the width of the histogram bin.

FIG. 16B provides a similar example for a four-detector macropixel in a pile-up situation. As illustrated in FIG. 16B, the distribution of the counts may be narrower due to the pile-up scenario. However, the rising edge 630 and the peak 610 of the histogram may be determined, and the leading edge 610 of the return signal may be determined as being separated (e.g., in terms of distance) from the rising edge 630 of the histogram by (Tbin)*(c/2). This assumes a symmetric laser pulse. If the laser pulse is not symmetric, a different, but fixed, offset may be used. FIG. 16B shows an extreme level of pile up where the detector activates almost entirely from photons arriving from the leading edge of the return signal pulse. However, the level of pile up may not be known a-priori and may depend on reflectivity and distance. If a center of mass is used the pile up will cause an uncertain deviation of the estimated distance by up to PW/2×c/2, even with a high resolution TDC. In embodiments of the present disclosure, however, the rising edge 630 will be preserved regardless of the level of pile up (the rising edge 630 measures the first arrival of photons from the return signal pulse). The computation method described herein compensates for the offset between the center of mass and the leading edge estimates. Embodiments described herein locate the leading edge of the return signal with N times (e.g., 4 times in FIG. 16B) better resolution than with a single pixel histogram.

FIG. 16C provides a similar example for a four-detector macropixel in a partial pile-up situation. As illustrated in FIG. 16C, the partial pile-up may shift the peak of the summed histograms slightly, but the rising edge 630 of the summed histogram may still be detected, and the leading edge 610 of the return signal may still be determined based on its separation from the rising edge 630 of the histogram by (Tbin)*(c/2).

Though FIGS. 16A to 16C illustrate finding the leading edge of the return signal based on a fixed offset from the rising edge of the summed histograms, the embodiments described herein are not limited to this method. In some embodiments, a function that takes into consideration a configuration of the macropixel and/or detector may be used to determine the location of the leading edge. For example, in some embodiments, a lookup table and/or other deterministic model may be used to provide an adjustment to estimate the leading edge of the return signal.

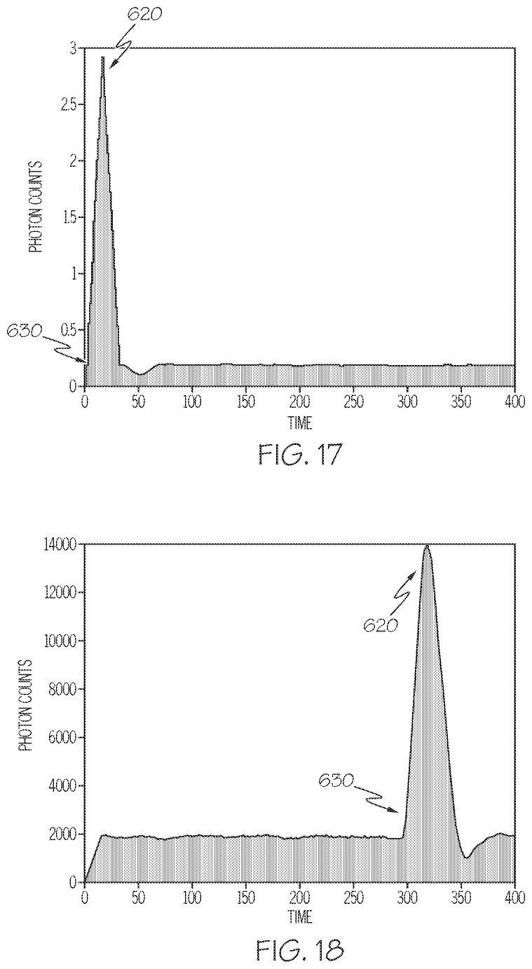

FIGS. 17 and 18 illustrate examples of a method of determining a leading edge of a return signal based on a time-aligned summation of histograms from a plurality of time-offset detectors, according to some embodiments of the present disclosure. FIGS. 17 and 18 illustrate examples of a histogram summation, as discussed herein, which can be made by summing the photon counts from a plurality (e.g., N) detectors, each of which are operated utilizing strobe windows that are offset from the other detectors by a particular time offset.

As illustrated in FIG. 17, the method may include finding a peak 620 of the summed histogram. The peak 620 may be a time point or duration that is associated with a highest value of photon counts of the summed photon counts.

An average background level of the histogram environment may be determined. The average background level may refer to a level of background, or ambient, noise that is present in the detected photons that is not correlated to the emitter signal. The background noise may be due to other light sources in the environment of the lidar system. Determining the background level may be performed using techniques known by those of ordinary skill in the art.

A rising edge 630 of the summed histogram may be determined by detecting where the peak 620 begins to rise from the background noise. In some embodiments, this can be detected by determined where the summed histogram rises at least three sigma above the average background noise. The value of three sigma is merely an example, and other values may be used without deviating from the present disclosure.

Once the rising edge 630 and peak 620 are known, the leading edge of the return signal may be determined from the rising edge 630 and the peak 620 as described herein (e.g., as a fixed offset from the rising edge 630 or using a deterministic function, such as by a predetermined lookup table). FIG. 18 provides another example of determining the peak 620 and rising edge 630, according to some embodiments of the present disclosure.

Though the range estimation techniques discussed herein for determining the leading edge of a return signal are described using examples associated with a macropixel having a plurality of detectors whose activations are each offset from one another, it will be understood that this technique is not limited to this embodiment. In some embodiments the operations described herein may also be applied to counts that are associated with configurations in which the detectors of respective subframes are activated offset with respect to one another, such as described herein with respect to FIGS. 3 to 12.

A single-pixel technique for range estimation may have higher mean errors at shorter ranges but may have a lower error at larger ranges (e.g., 10-30 m, or larger). This larger error may be due to pile-up effects that can occur at closer ranges. A dithered spatial macropixel utilizing range estimation techniques as described herein may have a smaller error at closer ranges (e.g., less than 10 m). Thus, as described herein an improvement can be achieved by utilizing a detector approach that incorporates a range estimation based on a macropixel combination of detectors for shorter ranges and utilizes the histograms from individual detectors of the macropixel at longer ranges.

An added advantage of the use of summed histograms is that it may bound strong returns more tightly. For example, stray light from a specular reflector, such as a retroreflector, may be reflected back to many detectors in the image causing piled-up distanced estimates to appear erroneously up to Tclk*c/2 closer to the observer than is the case. By looking across the dithered spatial macropixel histograms, it may be possible to confine the stray light and separate the signature of the stray light from the return from objects within Tclk*c/2 of the retroreflector. Without such spatial dithering, the stray light peak may obscure other signals within Tclk*c/2. The use of the dithered spatial macropixel histograms may provide the ability to separate other surfaces at around a same range as the retroreflector stray light by looking across the dithered spatial detectors.

In addition, the use of the dithered spatial macropixel may tend to spread the power draw of the detectors more uniformly. A single synchronous clock distributed by H-tree applied to a number of detectors simultaneously may draw a very large simultaneous spike of current, thus complicating power management and generating a need for large decoupling and careful power metal usage. In addition, with the embodiments described herein, there is less likely to be corruption of the detector arithmetic due to IR drops in the centre of the detector array. Also, some of the embodiments described herein require little to no extra power draw from clocking, as the utilization of increased frequencies may be avoided except in a DLL generating the phases.

In some embodiments, spatial dithering may assist discerning two targets within close range of one another. In conventional methods (or in some embodiments utilizing temporal dithering), the two return signals from the two near-range targets may fuse together due to the use of a dithered histogram. As a result, the lidar system may not be able to identify the existence of two targets or their range. With spatial dithering, the range fidelity of the lidar system may be maintained because the histograms of each dither may be read out separately. Thus, embodiments described herein may provide a method for improving range resolution while maintaining the fidelity of the system.

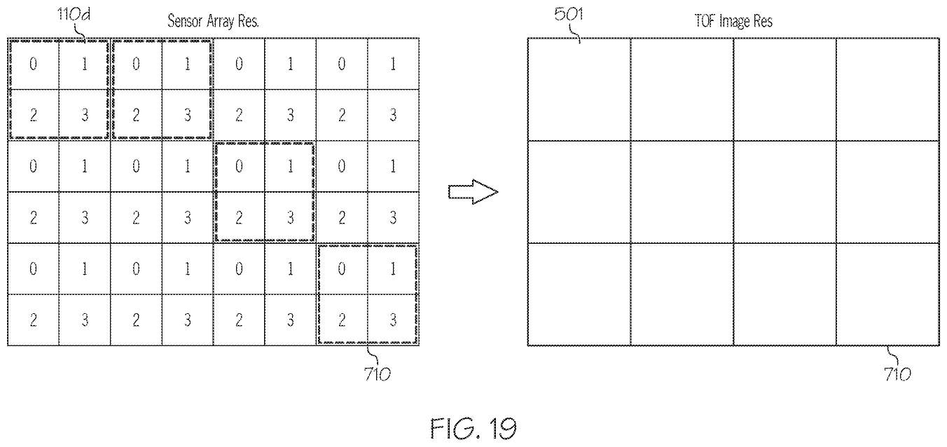

FIG. 19 is a schematic diagram of a conversion of an array of detectors to an array of macropixels, according to some embodiments of the present disclosure. In some embodiments, the use of N multiple detectors to generate a combined histogram rather than generating N separate histograms may result in a reduction in angular resolution. This phenomenon is illustrated in FIG. 19 in which an 6×8 array of detectors 110d is utilized to create an effective 3×4 array of macropixels 501 (each having four detectors 110d). In FIG. 19, detectors 110d with a ‘0’ label have a first offset, detectors 110d with a ‘1’ label have a second offset, detectors 110d with a ‘2’ label have a third offset, and detectors 110d with a ‘3’ label have a fourth offset. This trades off the angular resolution per processed detector (boundaries 710) to half that of the individual detector element. Because the level of angular resolution needed in the distance ranges for which the dithered macropixel excels is lowered, this tradeoff may be acceptable. However, other techniques may be utilized to increase the resolution and/or to reduce artifacts at boundaries where two objects at different ranges are partially occluded within a macropixel.

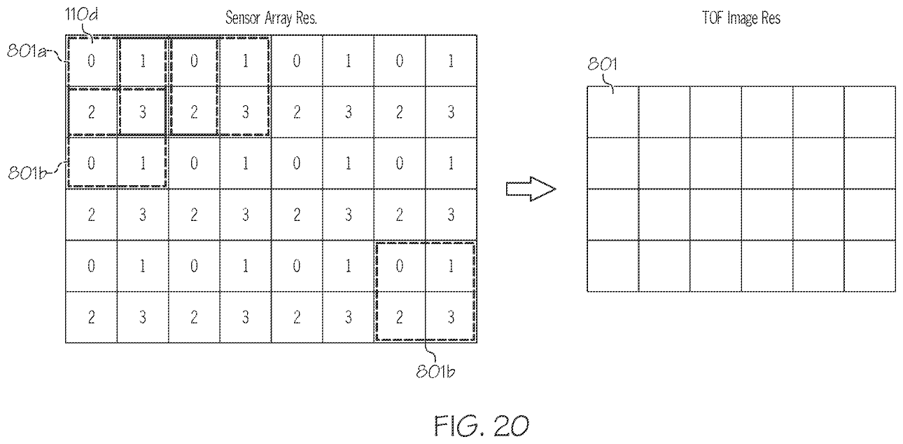

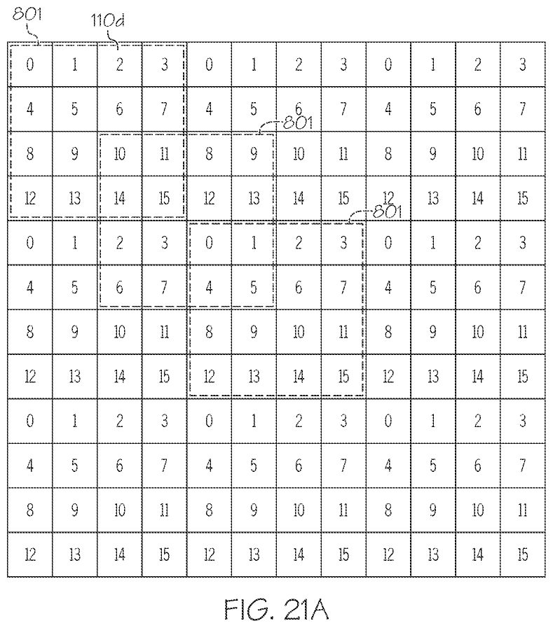

FIG. 20 is a schematic diagram of the formation of a plurality of macropixels 801 from a set of detectors 110d, according to some embodiments of the present disclosure. In some embodiments, time-aligned histograms may be summed from many different combinations of detectors 110d to form a plurality of macropixels 801. Referring to FIG. 20, macropixels 801 may be dynamically formed from the detectors 110d of a detector array. In FIG. 20, detectors 110d with a ‘0’ label have a first offset, detectors 110d with a ‘1’ label have a second offset, detectors 110d with a ‘2’ label have a third offset, and detectors 110d with a ‘3’ label have a fourth offset. Though four offsets are used in FIG. 20, this is merely an example and not intended to limit the disclosure.

Due to the symmetrically repetitive nature of the distributed phases/offsets, it is possible to combine any four phases/offsets (in this example) of the detectors 110d to form a macropixel 801 in a moving window technique. As illustrated in FIG. 20, a first macropixel 801a may be formed of a first set of detectors 110d and a second macropixel 801b may be formed of a second, different, set of detectors 110d. One or more detectors 110d may be in both the first macropixel 801a and the second macropixel 801b. Certain of the detectors 110d may be included in as many as four pixels (in this example). The combining of the detectors 110d results in a larger number of summed histograms utilizing different combinations of detectors 110d. In some embodiments, these combinations may result in a TOF image resolution that is the same or similar to the detector array native resolution minus the detectors 110d on the edge of the array (which may not be capable of being combined with other detectors 110d in all directions).

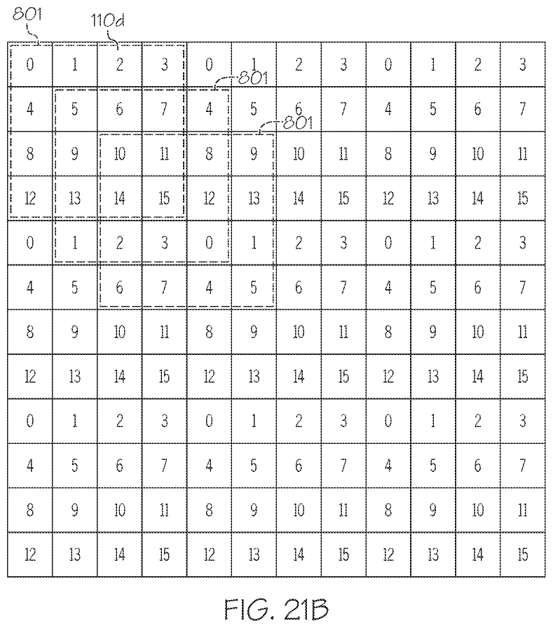

The detectors 110d of the array may be combined (and their resulting histograms summed) in a number of ways. For example, FIG. 21A illustrates a coarse combination of detectors 110d arranged in an N=16 macropixel 801. As shown in FIG. 21A, the coarse combination may not utilize all the possible combinations of the detectors 110d, but may make use of enough combinations to meet the operational requirements of the lidar system. FIG. 21B illustrates the same N=16 dithered detector array, but illustrates that finer combinations may be made that incorporate individual detectors 110d in a larger number of macropixels 801 to increase the resolution of the system. For example, as illustrated in FIG. 21B, two respective macropixels 801 may share nine of the sixteen detectors 110d, as compared with four detectors 110d in FIG. 21A.

In some embodiments, the lidar system may not utilize every combination in every scenario. In some embodiments, the lidar system may selectively choose particular combinations based on determined characteristics of the environment. For example, in some embodiments, the lidar system may use collected intensity data and/or determined intensity data to determine the best suitable combination for target(s) in FOV of the lidar system.

In some embodiments, selection of the macropixel configuration and/or the use of the range estimation techniques described herein may be based on the range of the target. For example, in some embodiments, a single strobe window may be used per frame (e.g., no power stepping), and the outputs (e.g., the photon counts) of all of the detectors in a macropixel may be read out. A processing circuit may determine an estimated range of the target based on the read-out value. If the target is determined to be at a close range (e.g., within one-third of the maximum distance of the system), then the dithered histograms may be combined. For example, time-aligned bins of the histograms from the detector may be combined. Such a technique may provide finer range resolution and higher dynamic range and the ability to deal with bright reflectors at the price of lower angular resolution. If the target is determined to be at a farther range (e.g., greater than one-third of the maximum distance of the system) then the histograms from the detectors may be processed individually, thus delivering higher angular resolution with lower range resolution.

Some embodiments of the present invention may utilize the data collected by macropixel configurations as described herein (e.g., as shown in FIGS. 13A to 13C) differently depending on the range of a target.

In particular, as each macropixel includes multiple detector elements or pixels operated by respective timing signals that are offset from one another (e.g., by respective fractions of a bin) during the time between consecutive emitter pulses, the histogram data collected at the respective offsets may be processed differently in order to increase range precision for targets at closer ranges while sacrificing angular resolution, or to maintain angular resolution for targets at farther ranges with baseline precision.

For example, for strobe windows corresponding to closer distance sub-ranges (or for earlier-detected times of arrival), e.g., corresponding to 0-50 m distance sub-ranges, the data collected at the different offsets may be processed collectively to provide finer range resolution (or “super-resolution”) based on the collection of more samples identified as corresponding to the particular distance sub-range at sub-bin offsets from each other. That is, with the knowledge that the target is at a closer distance sub-range (e.g., 10-20 m) and that the target spans a whole macropixel, the histogram data corresponding to the different offsets may provide finer range information over that sub-range (e.g., each offset may indicate detection of targets at 0.1 m increments over the 10 m sub-range), thereby allowing for increased precision in range calculation, but at the expense of reduced angular resolution.

Conversely, for strobe windows corresponding to farther distance sub-ranges (or for later-detected times of arrival), e.g., corresponding to 150-200 m distance sub-ranges, the data collected at the different offsets may be processed individually to provide finer angular resolution, as the data collected at each offset may be identified as corresponding to a respective portion of the field of view at the farther distance sub-range (albeit with less range accuracy due to the different offsets). That is, with the knowledge that the target is at a farther distance sub-range (e.g., 190-200 m), the histogram data corresponding to each offset may provide finer angular information over that sub-range (e.g., each offset may indicate detection of targets at 0.5 degree increments over the FOV for the 10 m sub-range), thereby allowing for increased angular resolution, but with reduced accuracy in range calculation (which may be of lesser concern for far-range targets). For range calculations at farther distance sub-ranges, the range determination may take into account the sub-bin offset. For example, typically the range is calculated as x=ct/2, but with a sub-bin offset of b/n, where b is the time-based width of the bin and n is the number of offsets and/or pixels in the macropixel (e.g., b/3 for the 3^{rd} pixel in the micropixel), the range may be calculated as x=c(t+[b/n])/2.

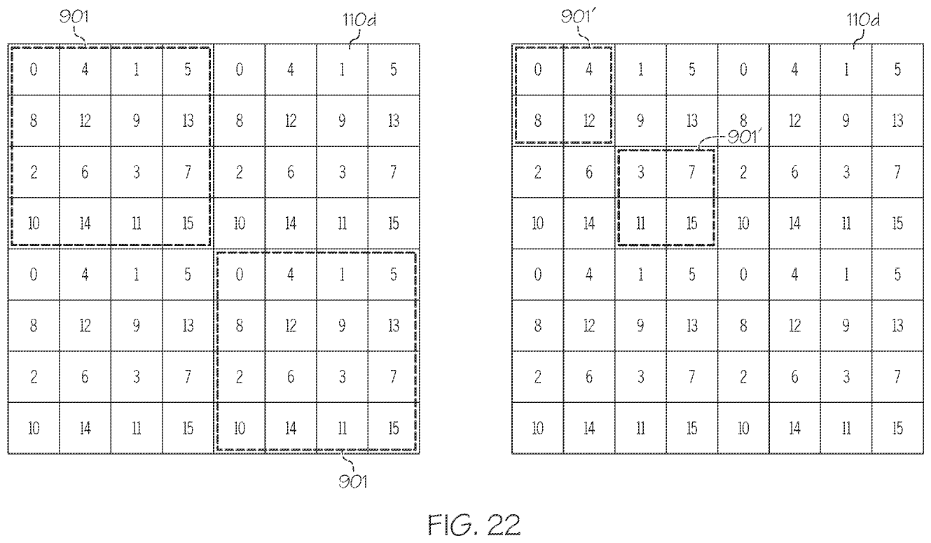

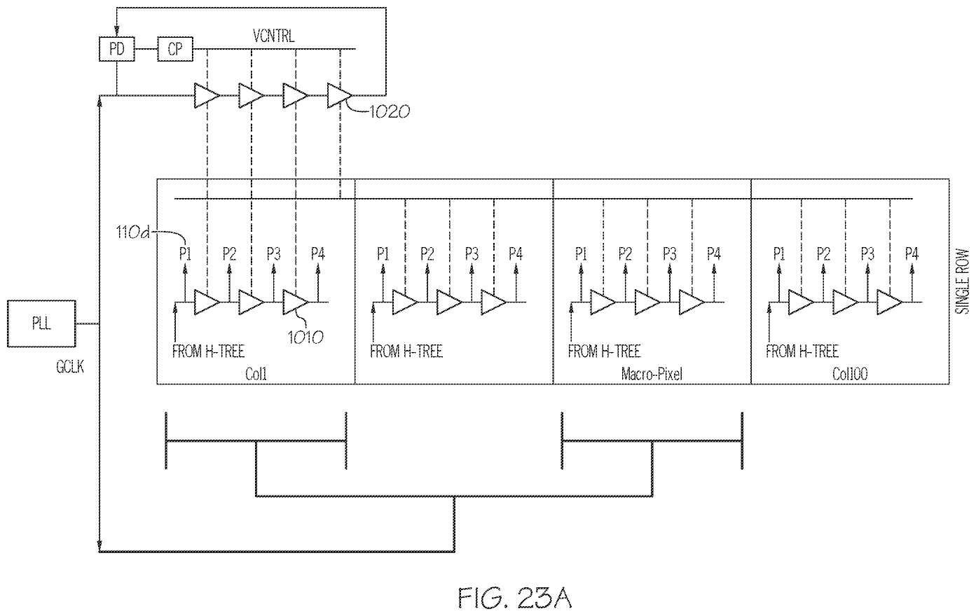

FIG. 22 is a schematic diagram illustrating an example of combining detectors 110d according to some embodiments of the present disclosure. In some embodiments, macropixels 901 may be formed by rearranging the phases/offsets of the detectors 110d to form different macropixels 901′. For example, referring to FIG. 22, the lidar system may begin with a first macropixel 901 (shown here as a 4×4 macropixel 901). The lidar system may subsequently regroup the detectors 110d to form a second macropixel 901′ (shown here as a 2×2 macropixel 901′). The detectors 110d of the second macropixel 901′ may still have strobe windows that are offset with respect to one another, as in the previous examples. Rearranging the phases of the detectors 110d may allow for various patterns of combination. For example, the lidar system may use the first macropixel 901 (e.g., a 4×4 macropixel) for fine temporal resolution and lower spatial resolution as previously described. The lidar system may transition to the second macropixel 901′ (e.g., a 2×2 macropixel) for less fine temporal resolution and finer spatial resolution. This combination is merely an example, and it will be understood that other combinations of detectors 110d are possible without deviating from the scope of the present disclosure. As illustrated in FIG. 22, the offsets of the various detectors 110d need not necessarily proceed sequentially within a macropixel 901.

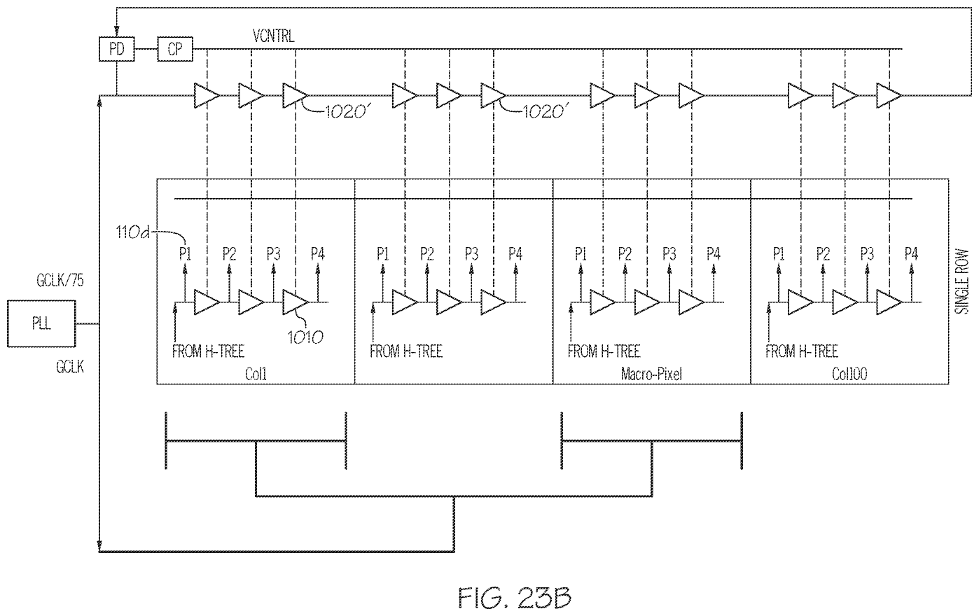

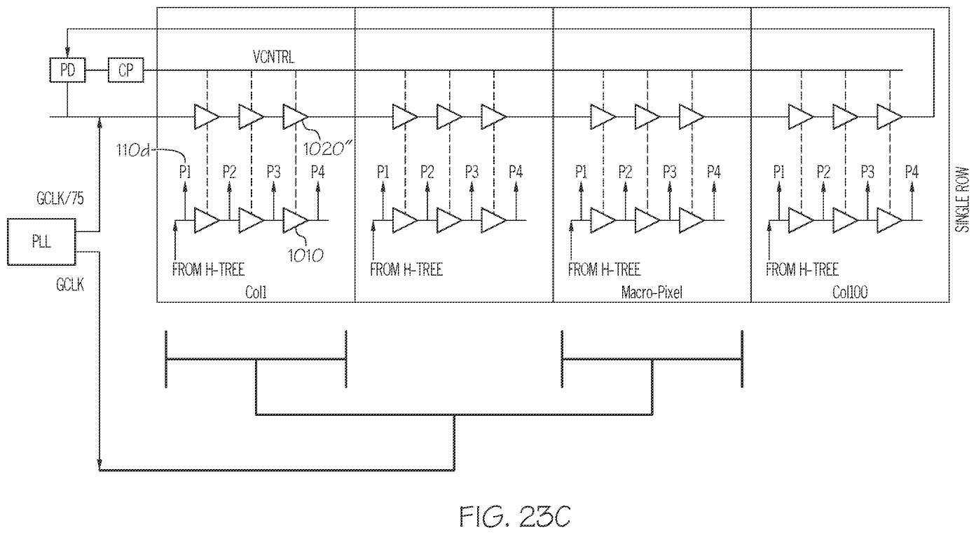

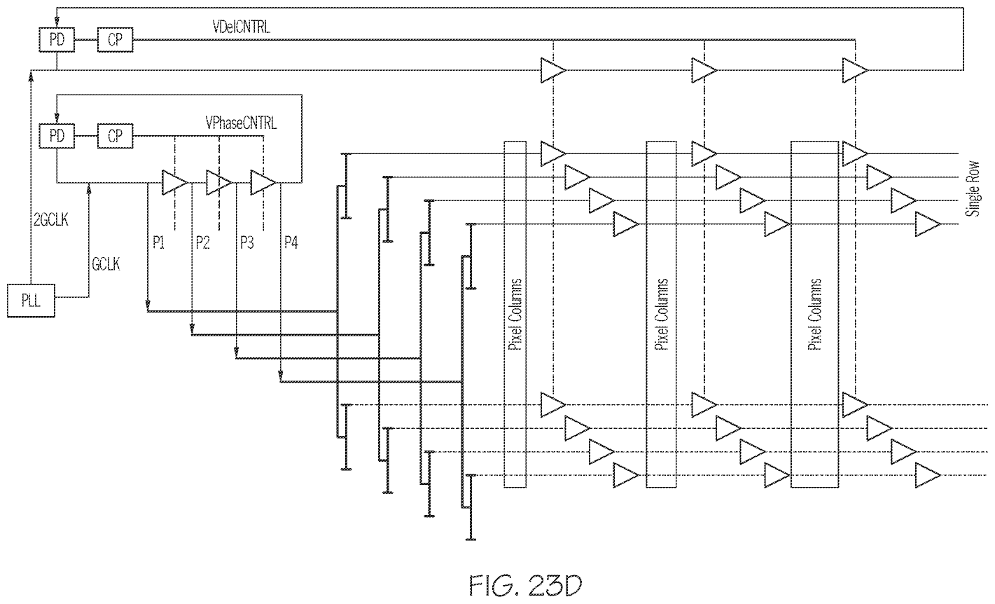

FIGS. 23A to 23D illustrate example circuits for generating the time offsets for the detectors of a macropixel, according to some embodiments of the present disclosure. While only four detectors 110d are illustrated in FIGS. 23A to 23D, it will be understood that this is merely an example and not intended to limit the present disclosure. Referring to FIG. 23A, a clock signal GCLK may be distributed to each of the detectors 110d (illustrated as P1, P2, P3, P4 for the phases of the four detectors 110d of a macropixel). In some embodiments, the clock signal GCLK may be distributed by an H-tree, but the present disclosure is not limited thereto. The clock signal GCLK may provide an activation signal (e.g., a strobe activation signal defining a strobe window) to the detector 110d.

The clock signal GCLK may be passed through a series of delay elements 1010 (e.g., a buffer). Each delay element may adjust the phase/offset of the clock signal GCLK provided to the detectors 110d. In FIG. 23A, four detectors 110d are provided with four offsets from three delay elements 1010, but this is merely an example, and the present disclosure is not limited thereto. A delay locked loop (DLL) may be provided to maintain the control voltages of the delay elements 1010 from a global control voltage VCNTRL to be insensitive to and/or less impacted by process, temperature, and supply voltage variations. Control elements 1020 (e.g., buffers) may be used in the DLL to generate the control voltages globally to the delay elements 1010 of all of the macropixels.

FIG. 23B illustrates a variation in which the DLL maintains control elements 1020′ for each of the macropixels in a row. This may allow for adjustments to the control voltages of the delay elements 1010 to compensate for the position of the macropixel within the row.

FIG. 23C illustrates a variation in which a DLL is maintained for every row. Each row has a DLL that maintains control elements 1020″ for each of the macropixels in that same row. This may allow for finer adjustments to the control voltages of the delay elements 1010 to compensate for the position of the macropixel within the row as well as between rows.

FIG. 23D illustrates a variation in which a clock signal GCLK can be delivered to the columns of the detector array (labelled as “Pixel Columns”) without requiring a use of an H-tree. In FIG. 23D, a first DLL VPhaseCNTRL may control the generation and distribution of clock signals having a phase offset as strobe windows to the detectors. A second DLL VDelCNTRL may control additional delays for each of the phase signals to adjust for skew of the signal within the row.

The embodiments described herein provide a mechanism by which distances to a target may be determined to a high resolution despite the presence of highly reflective target. As will be understood by one of ordinary skill in the art, the techniques described herein do not necessarily need to be applied to all distances across a range and/or field of view of the lidar system. In some embodiments, for example, the methods described herein may only be performed for a subset of the distances of the range of the LIDAR system. For example, the detection windows may be offset for portions of the frame acquisition that are associated with closer distances (e.g., one half or less of the detection distance/range of the LIDAR system), but may not be offset for other portions of the frame acquisition that are associated with farther distances. In some embodiments, the closer distances may be more prone to reflective targets.

Various embodiments have been described herein with reference to the accompanying drawings in which example embodiments are shown. These embodiments may, however, be embodied in different forms and should not be construed as limited to the embodiments set forth herein. Rather, these embodiments are provided so that this disclosure is thorough and complete and fully conveys the inventive concept to those skilled in the art. Various modifications to the example embodiments and the generic principles and features described herein will be readily apparent. In the drawings, the sizes and relative sizes of layers and regions are not shown to scale, and in some instances may be exaggerated for clarity.

The example embodiments are mainly described in terms of particular methods and devices provided in particular implementations. However, the methods and devices may operate effectively in other implementations. Phrases such as “example embodiment,” “one embodiment,” and “another embodiment” may refer to the same or different embodiments as well as to multiple embodiments. The embodiments will be described with respect to systems and/or devices having certain components. However, the systems and/or devices may include fewer or additional components than those shown, and variations in the arrangement and type of the components may be made without departing from the scope of the inventive concepts. The example embodiments will also be described in the context of particular methods having certain steps or operations. However, the methods and devices may operate effectively for other methods having different and/or additional steps/operations and steps/operations in different orders that are not inconsistent with the example embodiments. Thus, the present inventive concepts are not intended to be limited to the embodiments shown, but are to be accorded the widest scope consistent with the principles and features described herein.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

The terminology used herein is for the purpose of describing particular embodiments only and is not intended to be limiting of example embodiments. As used herein, the singular forms “a,” “an,” and “the” are intended to include the plural forms as well, unless the context clearly indicates otherwise. It also will be understood that, as used herein, the term “comprising” or “comprises” is open-ended, and includes one or more stated elements, steps and/or functions without precluding one or more unstated elements, steps and/or functions. The term “and/or” includes any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the scope of the present inventive concepts.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed embodiments of the disclosure and, although specific terms are employed, they are used in a generic and descriptive sense only and not for purposes of limitation, the scope of the present invention being set forth in the following claims.

1. A Time of Flight (ToF) system, comprising:
an emitter array comprising one or more emitters configured to emit optical signals;
a detector array comprising a plurality of detectors that are configured to output respective detection signals responsive to the optical signals that are reflected from a target; and
a control circuit configured to:
control the emitter array to emit a first optical signal; and
provide a plurality of activation signals to a subset of the plurality of detectors responsive to the first optical signal to activate respective ones of the detectors of the subset for a first duration to generate detection signals associated with the first optical signal,
wherein respective ones of the plurality of activation signals are offset from one another by respective time offsets.

2. The ToF system of claim 1, wherein the one or more emitters comprise a laser, and
wherein the respective time offsets are based on a pulse width of the first optical signal.

3. (canceled)

4. The ToF system of claim 1, wherein the first duration corresponds to a distance subrange of a distance range of the ToF system,
wherein the respective time offsets are associated with portions of the distance subrange, and
wherein, responsive to the first optical signal, respective durations of activation of the respective ones of the detectors are offset from one another by the respective time offsets and overlap in time.

5. The ToF system of claim 1, wherein the control circuit is further configured to divide the first duration into a plurality of bins, each bin having a bin width that is a subset of the first duration, and
wherein the detection signals are associated with one of the plurality of bins.

6. The ToF system of claim 5, wherein the respective time offsets are based on the bin width.

7. The ToF system of claim 5, wherein the control circuit is further configured to:
sum photon counts associated with time-aligned ones of the plurality of bins to generate a summed histogram;
detect a peak and a rising edge of the summed histogram; and
calculate a leading edge of a return signal associated with the first optical signal based on the peak and the rising edge of the summed histogram.

8-9. (canceled)

10. The ToF system of claim 1, wherein the subset of the plurality of detectors is a first subset, the detection signals are first detection signals, and the plurality of activation signals is first plurality, and
wherein the control circuit is further configured to:
control the emitter array to generate a second optical signal; and
provide a second plurality of activation signals to a second subset of the plurality of detectors to activate the second subset for the first duration to generate second detection signals associated with the second optical signal,
wherein respective ones of the plurality of second activation signals are offset from one another by the respective time offsets.

11. The ToF system of claim 10, wherein a first number of detectors in the first subset is different than a second number of detectors in the second subset.

12. The ToF system of claim 10, wherein the first subset comprises at least one first detector that is not included in the second subset and at least one second detector that is included in the second subset.

13. The ToF system of claim 10, wherein the first subset and the second subset are a same subset, and
wherein the control circuit is further configured to:
divide the first duration into a plurality of bins, each bin having a bin width that is a subset of the first duration;
calculate a first leading edge of a first return signal associated with the first optical signal by summing photon counts associated with time-aligned ones of the plurality of bins associated with the first subset to generate a summed histogram; and
calculate a second leading edge of a second return signal associated with the second optical signal by individually analyzing respective ones of the plurality of bins associated with the second subset.

14. (canceled)

15. The ToF system of claim 13, wherein the control circuit is further configured to calculate the second leading edge of the second return signal by compensating for the respective time offsets.

16. The ToF system of claim 13, wherein calculating the first leading edge of the first return signal associated with the first optical signal by summing photon counts associated with the time-aligned ones of the plurality of bins is performed responsive to determining that an estimated range of the target is less than a predetermined threshold value.

17. (canceled)

18. A Time of Flight (ToF) system, comprising:
an emitter array comprising one or more emitters configured to emit optical signals;
a detector array comprising one or more detectors that are configured to output respective detection signals responsive to the optical signals that are reflected from a target; and
a control circuit configured to:
control the emitter array and/or the detector array to generate first detection signals associated with a first subset of the optical signals that are received by the detector array during a first duration that corresponds to a distance subrange of a distance range of the ToF system;
control the emitter array and/or the detector array to generate second detection signals associated with a second subset of the optical signals that are received by the detector array during the first duration that corresponds to the distance subrange by varying, by respective time offsets, an elapsed time between an emission of the second subset of the optical signals by the one or more emitters and activation of the one or more detectors to detect the second subset of the optical signals; and
determine whether the target based is within the distance subrange based on the first and second detection signals.

19. The ToF system of claim 18, wherein the one or more emitters comprise a laser, and
wherein the respective time offsets are based on a pulse width of the second subset of the optical signals.

20. (canceled)

21. The ToF system of claim 18, wherein the control circuit is further configured to divide the first duration into a plurality of bins, each bin having a bin width that is a subset of the first duration,
wherein the first and second detection signals are associated with one of the plurality of bins, and
wherein the respective time offsets are based on the bin width.

22-23. (canceled)

24. The ToF system of claim 18, wherein the control circuit is further configured to vary, by the respective time offsets, the elapsed time between the emission of the second subset of the optical signals by the one or more emitters and the activation of the one or more detectors responsive to determining that a photon pile-up condition has occurred.

25-27. (canceled)

28. The ToF system of claim 18, wherein the control circuit is further configured to vary, by the respective time offsets, the elapsed time between the emission of the second subset of the optical signals by the one or more emitters and the activation of the one or more detectors based on varying respective timings of strobe signals transmitted to the detector array that controls activation times of the one or more detectors to detect the second subset of the optical signals.

29. The ToF system of claim 18, wherein the control circuit is further configured to vary, by the time offset, the elapsed time between the emission of the second subset of the optical signals by the one or more emitters and the activation of the one or more detectors based on varying respective activation times of the one or more emitters to emit the second subset of the optical signals.

30-32. (canceled)

33. The ToF system of claim 18, wherein the emitter array comprises a plurality of groups of the one or more emitters, and
wherein the control circuit is further configured to vary respective timings of activation signals sent to respective ones of the groups of the one or more emitters by the respective time offsets.

34. A Time of Flight (ToF) system, comprising:
one or more emitters that are configured to emit optical signals responsive to emitter control signals;
one or more detectors that are configured to be activated responsive to detector strobe signals, and are configured to output detection signals responsive to the optical signals that are reflected from a target; and
a control circuit configured to:
output the detector strobe signals corresponding to a respective distance subrange of the ToF system at different offsets or delays relative to respective timings of the emitter control signals; or
output the emitter control signals at different offsets or delays relative to respective timings of the detector strobe signals corresponding to a respective distance subrange of the ToF system.

35. The ToF system of claim 34, wherein a readout signal corresponding to the respective distance subrange comprises a distribution of the detection signals at the different offsets or delays.

36. The ToF system of claim 34, wherein the control circuit is further configured to:
associate a plurality of bins of a histogram with the respective distance subrange, each bin having a bin width that is a subset of a time duration that corresponds to the respective distance subrange; and
calculate a first leading edge of a first return signal associated with a first optical signal of the optical signals by summing photon counts associated with time-aligned ones of the plurality of bins of the histogram to generate a summed histogram.

37. The ToF system of claim 36, wherein the control circuit is further configured to calculate a second leading edge of a second return signal associated with a second optical signal of the optical signals by individually analyzing respective ones of the plurality of bins of the histogram and compensating for the different offset or delays.

38. (canceled)

39. The ToF system of claim 36, wherein calculating the first leading edge of the first return signal associated with the first optical signal by summing photon counts associated with the time-aligned ones of the plurality of bins is performed responsive to determining that an estimate range of the target is less than a predetermined threshold value.

40-48. (canceled)
